(19) United States
(12) Patent Application Publication
(10) Pub. No.: US 2023/0378660 A1
(43) Pub. Date: Nov. 23, 2023

(54) ANTENNA SYSTEM FOR VEHICLE

(71) Applicant: AGC Inc., Tokyo (JP)

(72) Inventors: Kouichirou TAKAHASHI, Tokyo (JP); Kiyoshi NOBUOKA, Tokyo (JP); Shoichi TAKEUCHI, Tokyo (JP); Hideaki SHOJI, Tokyo (JP); Yusuke KATO, Tokyo (JP); Toshiki SAYAMA, Tokyo (JP)

(73) Assignee: AGC Inc., Tokyo (JP)

(21) Appl. No.: 18/229,058

(22) Filed: Aug. 1, 2023

Related U.S. Application Data
(63) Continuation of application No. PCT/JP2022/003921, filed on Feb. 2, 2022.

(30) Foreign Application Priority Data
Feb. 5, 2021 (JP) 2021-017622

(51) Int. Cl. H01Q 21/06; H01Q 1/32; H04B 7/0413

(52) U.S. Cl. CPC H01Q 21/061; H01Q 1/32; H04B 7/0413

(57) ABSTRACT

An antenna system for vehicle includes a vehicle and a MIMO antenna that is mounted on the vehicle and that transmits and receives radio waves of a predetermined frequency. The MIMO antenna includes antennas including a first antenna that mainly transmits and receives a first polarized wave and a second antenna that mainly transmits and receives a second polarized wave orthogonal to the first polarized wave, and the antennas are dispersedly arranged on the vehicle. One of the first antenna and the second antenna are arranged based on at least one of (1) a configuration in which one is arranged in a central region and another one is arranged in a first peripheral region or a second peripheral region and (2) a configuration in which one is arranged in a first region and another one is arranged in a second region.

### INCORPORATION BY REFERENCE

This application is a Bypass Continuation of International Patent Application No. PCT/JP2022/003921, filed on Feb. 2, 2022, which is based upon and claims the benefit of priority from Japanese Patent Application 2021-017622, filed on Feb. 5, 2021. The contents of the applications are incorporated herein by reference in their entireties.

### BACKGROUND

The present invention relates to an antenna system for vehicle.

In recent years, high-speed and large-capacity communication infrastructure using radio waves in frequency bands of 4G LTE (Long Term Evolution) (800 MHz band), 5G (sub6 (less than 6 GHz)), quasi-millimeter waves (20 GHz to 30 GHz), and millimeter waves (30 GHz to 300 GHz) is expanding. Accordingly, the spread of vehicles equipped with 4G LTE/5G antenna is also accelerating.

A vehicle using 4G LTE/5G antenna is mounted with antennas, which can transmit and receive radio waves of a predetermined frequency, at a plurality of locations. A MIMO (Multiple Input Multiple Output) antenna is known as a technology for increasing a communication capacity of radio waves in a predetermined frequency band for antennas mounted on such a vehicle (for example, Japanese Unexamined Patent Application Publication No. 2016-143955 and Japanese Unexamined Patent Application Publication No. 2019-149612). Japanese Unexamined Patent Application Publication No. 2016-143955 discloses a MIMO antenna attached to a location of a windshield that do not overlap with a sun visor. Japanese Unexamined Patent Application Publication No. 2019-149612 discloses that a MIMO antenna is used as an example of integrated antenna modules dispersedly arranged in a plurality of locations of a vehicle.

### SUMMARY

For the on-vehicle MIMO antennas disclosed in Japanese Unexamined Patent Application Publication No. 2016-143955 and Japanese Unexamined Patent Application Publication No. 2019-149612 described above, large-volume data can be desirably communicated, but is not necessarily sufficient.

The present invention has been made in view of the-above problem, and an object thereof is to an antenna system for vehicle mounted with a MIMO antenna capable of improving a communication capacity.

A first aspect according to the present invention provides an antenna system for vehicle including a vehicle; and a MIMO antenna that is mounted on the vehicle and transmits and receives radio waves of a predetermined frequency, in which: the MIMO antenna includes four antennas including a first antenna that mainly transmits and receives a first polarized wave and a second antenna that mainly transmits and receives a second polarized wave orthogonal to the first polarized wave, the four antennas being dispersedly arranged on the vehicle, and when a central region is defined as a region having widths equidistant to each other in a left-right vehicle width direction from the center line that bisects a vehicle width when viewed in a vertical direction of the vehicle, a first peripheral region and a second peripheral region are defined as two regions with the central region interposed therebetween, a first region is defined as a front region of the vehicle using an arbitrary line extending in the vehicle width direction as a boundary, and a second region is defined as a rear region of the vehicle relative to the first region, the first antenna and the second antenna are arranged based on at least one of (1) a configuration in which one is arranged in the central region and another one is arranged in the first peripheral region or the second peripheral region and (2) a configuration in which one is arranged in the first region and another one is arranged in the second region.

In the antenna system for vehicle described above, the MIMO antenna may include a third antenna that mainly transmits and receives the first polarized wave and a fourth antenna that mainly transmits and receives the second polarized wave.

In the antenna system for vehicle described above, one of a first antenna group including the first antenna and the third antenna and a second antenna group including the second antenna and the fourth antenna may be arranged in the central region, and another one may be arranged in at least one of the first peripheral region and the second peripheral region.

In the antenna system for vehicle described above, the first antenna and the third antenna may be arranged in the central region, the second antenna may be arranged in the first peripheral region, and the fourth antenna may be arranged in the second peripheral region; or the first antenna may be arranged in the first peripheral region, the third antenna may be arranged in the second peripheral region, and the second antenna and the fourth antenna may be arranged in the central region.

In the antenna system for vehicle described above, the first antenna and the third antenna may be arranged at positions apart by the same distance from the center line, and the second antenna and the fourth antenna may be arranged at positions apart by the same distance from the center line.

In the antenna system for vehicle described above, the arbitrary line may be provided on a roof of the vehicle, and the MIMO antenna may be arranged in the first region or the second region.

In the antenna system for vehicle described above, the MIMO antenna may be arranged on a windshield.

In the antenna system for vehicle described above, the MIMO antenna may be arranged on a rear window.

In the antenna system for vehicle described above, the arbitrary line may be provided on a roof of the vehicle; and one of a first antenna group including the first antenna and the third antenna and a second antenna group including the second antenna and the fourth antenna may be arranged in the first region, and another one may be arranged in the second region.

In the antenna system for vehicle described above, one of the first antenna group and the second antenna group may be arranged on a windshield, and another one may be arranged on a rear window.

In the antenna system for vehicle described above, when the predetermined frequency is defined as λ, a wavelength shortening rate of a dielectric to which the first antenna and the third antenna are attached is defined as k₁, and a wavelength shortening rate of a dielectric to which the second antenna and the fourth antenna are attached is defined as k₂, a distance between the first antenna and the third antenna may be k₁×λ/2 or more, and a distance between the second antenna and the fourth antenna may be k₂×λ/2 or more.

In the antenna system for vehicle described above, the first polarized wave may be a vertically polarized wave, and the second polarized wave is a horizontally polarized wave, the first antenna may be a vertically polarized wave antenna that mainly transmits and receives the vertically polarized wave, and the second antenna may be a horizontally polarized wave antenna that mainly transmits and receives the horizontally polarized wave.

In the antenna system for vehicle described above, the first polarized wave may be a vertically polarized wave, and the second polarized wave is a horizontally polarized wave, the first antenna and the third antenna may be vertically polarized wave antennas that mainly transmit and receive the vertically polarized wave, and the second antenna and the fourth antenna may be horizontally polarized wave antennas that mainly transmit and receive the horizontally polarized wave.

In the antenna system for vehicle described above, a width Wc of the central region may satisfy a relationship of 0.1×W≤Wc≤0.5×W when a width of the vehicle is defined as W.

In the antenna system for vehicle described above, an antenna, which is arranged in either the first peripheral region or the second peripheral region, in the MIMO antenna may be arranged apart from a pillar of the vehicle by a distance of 100 mm or less.

In the antenna system for vehicle described above, the predetermined frequency may be 3.3 GHz or more.

In the antenna system for vehicle described above, the predetermined frequency may be 6 GHz or less.

According to an aspect of the present invention, it is possible to an antenna system for vehicle mounted with a MIMO antenna capable of improving a communication capacity.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram of a vehicle of an antenna system for vehicle according to Example 1 as viewed from above;

FIG. 2 is a plan view showing a windshield and an enlarged view of a first peripheral region;

FIG. 3 is a diagram of a vehicle of an antenna system for vehicle according to Example 2 as viewed from above;

FIG. 4 is a diagram of a vehicle of an antenna system for vehicle according to Example 3 as viewed from above;

FIG. 5 is a plan view showing a windshield;

FIG. 6 is a diagram of a vehicle of an antenna system for vehicle according to Example 4 as viewed from above;

FIG. 7 is a diagram of a vehicle of an antenna system for vehicle according to Example 5 as viewed from above;

FIG. 8 is a plan view showing a rear window;

FIG. 9 is a diagram of a vehicle of an antenna system for vehicle according to Example 6 as viewed from above;

FIG. 10 is a diagram of a vehicle of an antenna system for vehicle according to Example 7 as viewed from above;

FIG. 11 is a diagram of a vehicle of an antenna system for vehicle according to Example 8 as viewed from above;

FIG. 12 is a diagram of a vehicle of an antenna system for vehicle according to Example 9 as viewed from above;

FIG. 13 is a diagram of a vehicle of an antenna system for vehicle according to Example 10 as viewed from above;

FIG. 14 is a diagram of a vehicle of an antenna system for vehicle according to Example 11 as viewed from above;

FIG. 15 is a diagram of a vehicle of an antenna system for vehicle according to Example 12 as viewed from above;

FIG. 16 is a diagram of a vehicle of an antenna system for vehicle according to Example 13 as viewed from above; and

FIG. 17 is a diagram of a vehicle of an antenna system for vehicle according to Example 14 as viewed from above.

### DESCRIPTION OF EMBODIMENTS

A specific embodiment to which the present invention is applied will be described in detail below with reference to the drawings. However, the present invention is not limited to the following embodiment. For clarity of description, the following description and drawings are omitted and simplified as appropriate. In each drawing, the same components are denoted by the same reference numerals, and will not be described repeatedly as necessary. In each embodiment, deviations in parallel, horizontal, and vertical directions are allowed to the extent that the effects of the present invention are not impaired. In the drawings for describing the embodiment, when a direction is not specifically described, it means a direction on the drawings.

### Embodiment

A configuration example of an antenna system for vehicle according to an embodiment will be described below.

### Example 1

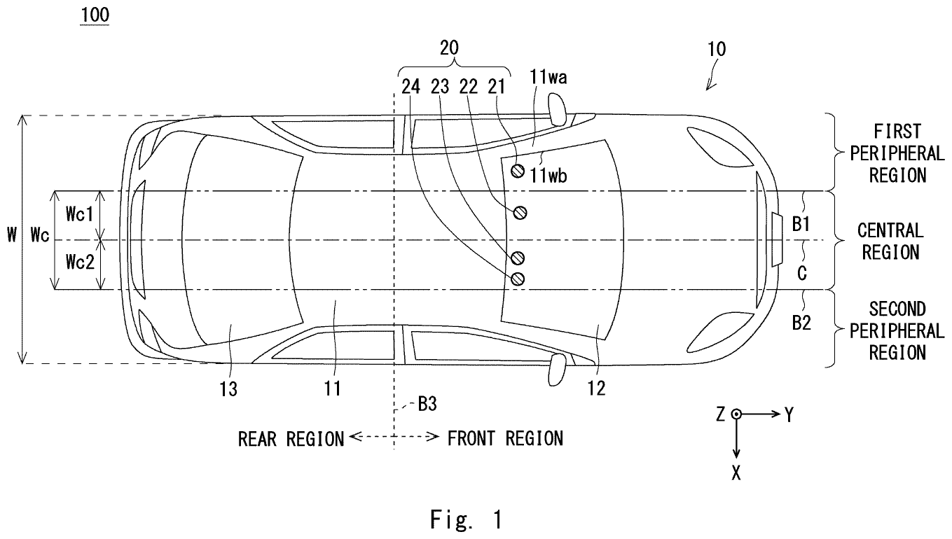

A configuration example of an antenna system for vehicle 100 according to Example 1 will be described with reference to FIG. 1. FIG. 1 is a diagram of a vehicle of the antenna system for vehicle according to Example 1 as viewed from above. The antenna system for vehicle 100 includes a vehicle 10 and a MIMO antenna 20.

In each of the drawings, an X-axis direction corresponds to a vehicle width direction of the vehicle 10, a Y-axis direction corresponds to a front-rear direction of the vehicle 10, and a Z-axis direction corresponds to an up-down direction of the vehicle 10. Further, an XY plane corresponds to a horizontal plane, and the Z-axis direction corresponds to a vertical direction perpendicular to the horizontal plane.

First, terms used in this description will be described prior to description of the configuration example of the antenna system for vehicle 100. In this description, virtual regions are used in which a region of the vehicle 10 is virtually divided. As shown in FIG. 1, a center line C is provided at a position that bisects a vehicle width when viewed in the vertical direction (positive direction of the Z-axis) of the vehicle 10, and a central region is defined as a region having widths equidistant to each other in a left-right vehicle width direction (X-axis direction) from the center line C. Specifically, a boundary line B1 is provided at a position distant by a distance Wc1 from the center line C in a negative direction of the X-axis of the central region, a boundary line B2 is provided at a position distant by a distance Wc2 equidistant to the distance Wc1 from the center line C in a positive direction of the X-axis of the central region, and a region between the boundary line B1 and the boundary line B2 is defined as the central region. A width Wc of the central region may be set so as to satisfy a relationship of 0.1×W≤Wc≤0.5×W with a vehicle width W of the vehicle 10.

Two regions with the central region interposed therebetween are defined as a first peripheral region and a second peripheral region. Specifically, a region from the boundary line B1 of the central region to a side of the vehicle 10 in the negative direction of the X-axis is defined as the first peripheral region, and a region from the boundary line B2 of the central region to a side of the vehicle 10 in the positive direction of the X-axis is defined as the second peripheral region. In FIG. 1, the first peripheral region and the second peripheral region may be defined interchangeably, and may be arranged so as to interpose the central region.

In addition, a reference line B3 extending in the vehicle width direction of the vehicle 10 is provided, a region in front of the vehicle (in a positive direction of the Y-axis) using the reference line B3 as a boundary is defined as a front region, and a region behind the front region from the reference line B3 is defined as a rear region. The reference line B3 may be set at any position. Further, the front region and the rear region are referred to as a first region and a second region, respectively.

The configuration example of the antenna system for vehicle 100 will be described below. The vehicle 10 includes a metal body 11, a windshield 12, and a rear window 13. The vehicle 10 may be any vehicle having any shape. In addition, the vehicle 10 may include at least one of side windows, front bench windows, rear quarter windows, and a roof window that serve as fixed windows.

The MIMO antenna 20 is an antenna which is mounted on the vehicle 10 and transmits and receives radio waves of a predetermined frequency, and is an antenna capable of multiple input/output at a predetermined frequency using a plurality of antennas connected to different feeding points. The predetermined frequency may be 3.3 GHz or more, and may be set to any frequency without any particular upper limit. Further, the predetermined frequency may be 6 GHz or less. The MIMO antenna 20 includes four antennas, which are antennas 21 to 24, and the antennas 21 to 24 are dispersedly arranged in the vehicle 10.

In Example 1, the reference line B3 is provided on a roof of the metal body 11 of the vehicle 10, and the MIMO antenna 20 is arranged in the front region. The MIMO antenna 20 is an antenna arranged on a dielectric, for example, on an in-vehicle surface side of the windshield 12. In other words, in Example 1, the antennas 21 to 24 are arranged on the in-vehicle surface side of the windshield 12 included in the front region. The antennas 21 to 24 may be directly attached to the windshield 12 in physical contact therewith. Alternatively, the antennas 21 to 24 may be indirectly attached to the windshield 12 with a housing interposed therebetween, for example.

The MIMO antenna 20 may be arranged in the rear region. In such a case, the MIMO antenna 20 may be arranged on the in-vehicle surface side of the rear window 13, may be arranged on the in-vehicle surface sides of the side windows, or may be arranged inside an aero part such as a rear spoiler. In addition, a shape of each of the antennas 21 to 24 may be arbitrary, for example, a patch antenna, a slot antenna, or a dipole antenna. In this description, the antenna 21, the antenna 22, the antenna 23, and the antenna 24 are also called a first antenna, a second antenna, a fourth antenna, and a third antenna, respectively.

The antenna 21 is an antenna that mainly transmits and receives a first polarized wave. The antenna, which mainly transmits and receives the first polarized wave, is an antenna of which an antenna gain for the first polarized wave is higher than an antenna gain for a second polarized wave orthogonal to the first polarized wave. In other words, the antenna, which mainly transmits and receives the first polarized wave, is an antenna of which a channel capacity in the first polarized wave is larger than a channel capacity in the second polarized wave. For the antenna that mainly transmits and receives the first polarized wave, when the antenna gain for the first polarized wave is G1 [dBi] and the antenna gain for the second polarized wave is G2 [dBi] at a predetermined frequency, a value of G1-G2 is sufficient to be 10 [dB] or more, and is preferable to be 15 [dB] or more. The first polarized wave may be a vertically polarized wave, a horizontally polarized wave, or a circularly polarized wave. When the first polarized wave is a vertically polarized wave, the second polarized wave is a horizontally polarized wave, and when the first polarized wave is a horizontally polarized wave, the second polarized wave is a vertically polarized wave. Furthermore, when the first polarized wave is a first circularly polarized wave, the second polarized wave is a second circularly polarized wave orthogonal to the first circularly polarized wave. The first circularly polarized wave and the second circularly polarized wave may be either a combination of a left polarized wave and a right polarized wave or a combination of a right polarized wave and a left polarized wave.

The antenna 21 is arranged in the first peripheral region, for example. The antenna 21 is arranged close to a pillar 11wa (A pillar 11wa) included in the metal body 11 of the vehicle 10, for example. The “arranged close to the pillar 11wa” means that the antenna 21 is arranged so close not to come into contact with the pillar. In other words, the antenna 21 is arranged close to an edge 11wb of the windshield 12 in the negative direction of the X-axis.

The antenna 22 is an antenna that mainly transmits and receives the second polarized wave. The antenna, which mainly transmits and receives the second polarized wave, is an antenna of which an antenna gain for the second polarized wave is higher than an antenna gain for the first polarized wave. For the antenna which mainly transmits and receives the second polarized wave, a value of G2-G1, which is a difference between the antenna gain for the second polarized wave and the antenna gain for the first polarized wave at a predetermined frequency is sufficient to be 10 [dB] or more, and is preferable to be [dB] or more.

The antenna 22 is arranged in the central region, for example. In Example 1, the antenna 22 may be arranged in the first peripheral region, and the antenna 21 may be arranged in the central region. In other words, Example 1 has a configuration in which one of the antenna 21 and the antenna 22 is arranged in the central region, and the other is arranged in the first peripheral region or the second peripheral region.

Each of the antennas 23 and 24 in this example may be an antenna that mainly transmits and receives the first polarized wave, or may be an antenna that mainly transmits and receives the second polarized wave. Furthermore, both of the antennas 23 and 24 may be antennas that transmit and receive the first polarized wave and the second polarized wave with the antenna gain at the same level and have no bias in channel capacity due to the polarized wave. Further, each of the antennas 23 and 24 may be dispersedly arranged in any one of the central region, the first peripheral region, and the second peripheral region. In the example shown in FIG. 1, the antennas 23 and 24 are arranged in the central region.

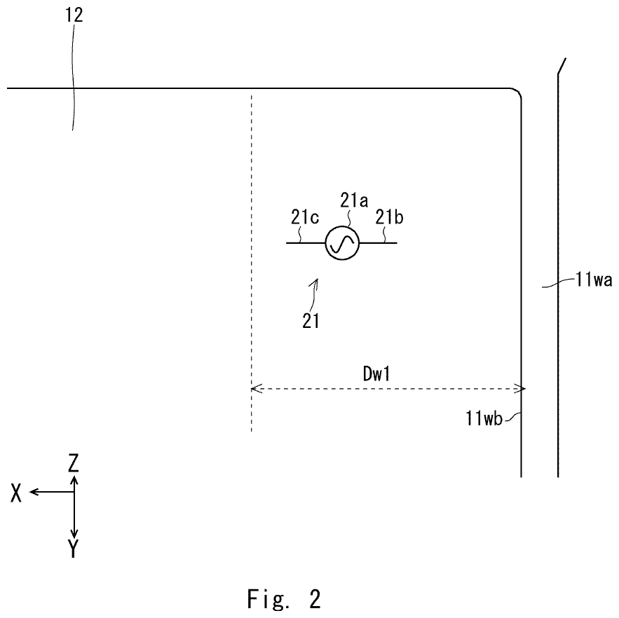

An arrangement example of the antenna 21 arranged in the first peripheral region will be described below with reference to FIG. 2. FIG. 2 is a plan view showing the windshield in a plan view and an enlarged view of the first peripheral region. As shown in FIG. 2, the antenna 21 includes, for example, a feeding unit 21a and antenna elements 21b and 21c. Like the antenna 21, each of the antennas 22 to 24 also includes a feeding unit and two antenna elements. In the following description, the feeding unit and the antenna elements of each of the antennas 21 to 24 will not be shown.

The antenna 21 is arranged in the first peripheral region, and is arranged close to the pillar 11wa adjacent to the edge 11wb of the windshield 12 in the negative direction of the X-axis in the metal body 11. The antenna 21 is arranged apart from the pillar 11wa within a distance Dw1. In other words, the distance Dw1 may be 100 [mm], or 50 [mm]. The same applies to the antenna arranged in the second peripheral region. In other words, the antenna arranged in the second peripheral region may be arranged apart from the pillar of the vehicle 10, and may be arranged within 100 [mm] or 50 [mm]. In addition, a distance between the antenna arranged in the second peripheral region and the pillar of the vehicle 10 may be equal to or different from the distance Dw1.

As described above, the antennas 21 to 24 included in the MIMO antenna 20 are dispersedly arranged in the vehicle 10. Further, one of the antennas 21 and 22 is an antenna that mainly transmits and receives the first polarized wave, and the other is an antenna that mainly transmits and receives the second polarized wave. Furthermore, one of the antennas 21 and 22 is arranged in the central region, and the other is arranged in the first peripheral region or the second peripheral region. In the antenna system for vehicle 100 including the antennas 21 and 22 of which the polarized waves are orthogonal to each other and which are arranged in different regions, even when the communication capacity of one polarized wave signal is low, the communication capacity is compensated by a communication capacity of the other polarized wave signal, and thus the stability of communication can be ensured. Therefore, since the antenna system for vehicle 100 includes the antennas 21 and 22 that function as antennas for ensuring the stability of communication, the communication capacity can be improved.

### Example 2

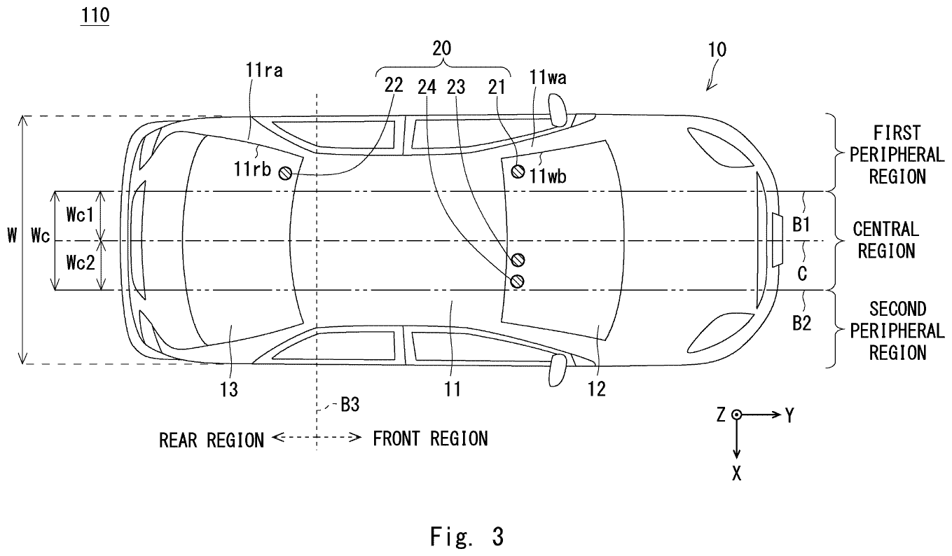

A configuration example of an antenna system for vehicle 110 according to Example 2 will be described below with reference to FIG. 3. FIG. 3 is a diagram of a vehicle of the antenna system for vehicle according to Example 2 as viewed from above. Example 2 has a configuration in which one of the antennas 21 and 22 is arranged in the front region and the other is arranged in the rear region. The antenna system for vehicle 110 is different in a position where the antenna 22 included in the MIMO antenna 20 is arranged from that of Example 1. Since the configuration examples of the vehicle 10 and the antennas 21 to 24 are the same as those of Example 1, the components common to the antenna system for vehicle 100 according to Example 1 will not be described as appropriate.

As shown in FIG. 3, the reference line B3 in Example 2 is provided on the roof of the vehicle 10 as in Example 1, but is provided at a position in the negative direction of the Y-axis compared with that of Example 1. The antennas 21, 23, and 24 are arranged on the in-vehicle surface side of the windshield 12 included in the front region. The antenna 22 is arranged in the rear region, for example, on the in-vehicle surface side of the rear window 13. The antenna 22 is arranged in the first peripheral region, for example. For example, the antenna 22 is arranged close to a pillar 11ra included in the metal body 11 of the vehicle 10, and is arranged apart from the pillar 11ra within a distance Dr1. In other words, the antenna 22 is arranged close to an edge 11rb of the rear window 13 in the negative direction of the X-axis, and is arranged apart from the edge 11rb within the distance Dr1. The distance Dr1 may be 100 [mm], or 50 [mm]. The distance Dr1 may be equal to or different from the distance Dw1.

Since the reference line B3 can be set at any position, the reference line B3 in Example 2 may be provided at the same position as the reference line B3 in Example 1. Since Example 2 has the configuration in which one of the antennas 21 and 22 is arranged in the front region and the other is arranged in the rear region, the antenna 21 may be arranged in the rear region, and the antenna 22 may be arranged in the front region. Further, since one of the antennas 21 and 22 may be arranged in the front region, for example, it is arranged inside an aero part (shark fin) provided near the center line C of a rear portion on the roof of the vehicle 10. Although being arranged in the first peripheral region in FIG. 2, the antennas 21 and 22 may be arranged in combination of the central region and the second peripheral region.

In Example 2, the antennas 21 to 24 of the MIMO antenna 20 are also dispersedly arranged in the vehicle 10 as in Example 1. Further, one of the antennas 21 and 22 is an antenna that mainly transmits and receives a first polarized wave, and the other is an antenna that mainly transmits and receives a second polarized wave. Furthermore, one of the antennas 21 and 22 is arranged in the front region, and the other is arranged in the rear region. In the antenna system for vehicle 110 including the antennas 21 and 22 of which the polarized waves are orthogonal to each other and which are arranged in different regions, even when the communication capacity of one polarized wave signal is low, the communication capacity is compensated by a communication capacity of the other polarized wave signal, and thus the stability of communication can be ensured. Therefore, as in the antenna system for vehicle 100 according to Example 1, since the antenna system for vehicle 110 includes the antennas 21 and 22 that function as antennas for ensuring the stability of communication, the communication capacity can be improved.

Although Examples 1 and 2 have been described as separate configurations, at least one of the antenna system for vehicle 100 and the antenna system for vehicle 110 may be configured by combination of the configurations of Examples 1 and 2. In other words, the configuration of Example 1, the configuration of Example 2, or the combination of the configurations of Examples 1 and 2 is possible. For this reason, the antennas 21 and 22 may be arranged to have at least one of (1) the configuration in which one is arranged in the central region and the other is arranged in the first peripheral region or the second peripheral region, and (2) the configuration in which one is arranged in the first region and the other is arranged in the second region.

Specific examples of Examples 1 and 2 will be described below.

### Example 3

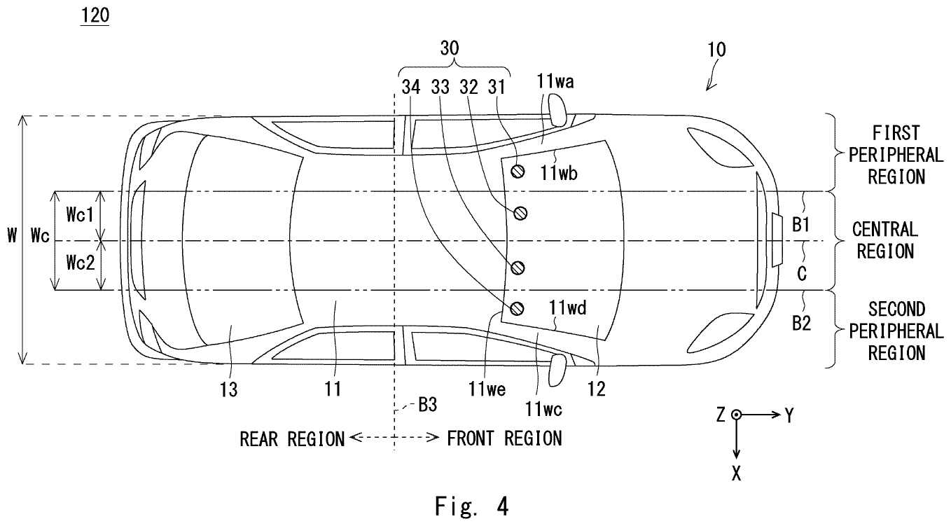

A configuration example of an antenna system for vehicle 120 according to Example 3 will be described with reference to FIG. 4. FIG. 4 is a diagram of a vehicle of the antenna system for vehicle according to Example 3 as viewed from above. The antenna system for vehicle 120 includes a vehicle 10 and a MIMO antenna 30. Example 3 is a specific example of Example 1, and has a configuration in which the MIMO antenna 30 is arranged in the front region. In the following examples including Example 3, the reference line B3 is provided on the roof of the metal body 11 of the vehicle 10 as in Example 1, but the reference line B3 may be provided at the same position as in Example 2.

The MIMO antenna 30 is an antenna which is mounted on the vehicle 10 and transmits and receives radio waves of a predetermined frequency, and is an antenna capable of multiple input/output at a predetermined frequency using a plurality of antennas connected to different feeding points. The predetermined frequency may be 3.3 GHz or more, and may be set to any frequency without any particular upper limit. Further, the predetermined frequency may be 6 GHz or less. The MIMO antenna 30 of this example is arranged on the windshield 12.

The MIMO antenna 30 includes four antennas, which are antennas 31 to 34, and the antennas 31 to 34 are dispersedly arranged in the vehicle 10. The antennas 31 to 34 are arranged on the in-vehicle surface side of the windshield 12. The antennas 31 to 34 may be directly attached to the windshield 12 in physical contact therewith. Alternatively, the antennas 31 to 34 may be indirectly attached to the in-vehicle surface side of the windshield 12 with a housing interposed therebetween, for example. The antennas 31 to 34 are arranged at positions that do not obstruct a view of occupants of the vehicle 10, and are arranged close to an upper edge 11we of the windshield 12, for example. A shape of each of the antennas 31 to 34 may be arbitrary as long as capable of transmitting and receiving radio waves of a predetermined frequency. Although the same applies to the following examples including Example 3, the antenna 31, the antenna 32, the antenna 33, and the antenna 34 are also called a first antenna, a second antenna, a fourth antenna, and a third antenna, respectively.

The antenna 31 corresponds to the antenna 21 in Examples 1 and 2. The antenna 31 is a vertically polarized wave antenna that mainly transmits and receives a vertically polarized wave. The antenna 31 may be a horizontally polarized wave antenna that mainly transmits and receives a horizontally polarized wave, or may be a circularly polarized wave antenna that mainly transmits and receives a circularly polarized wave. The circularly polarized wave may be a left polarized wave or a right polarized wave.

The antenna 31 is arranged on the in-vehicle surface side of the windshield 12 included in the front region, and is arranged in the first peripheral region. The antenna 31 is arranged close to a pillar 11wa included in the metal body 11 of the vehicle 10. In other words, the antenna 31 is arranged close to an edge 11wb of the windshield 12 in the negative direction of the X-axis.

The antenna 32 corresponds to the antenna 22 in Examples 1 and Example 2. The antenna 32 is a horizontally polarized wave antenna that mainly transmits and receives a horizontally polarized wave that is a polarized wave orthogonal to the polarized wave mainly transmitted and received by the antenna 31. The polarized wave mainly transmitted and received by the antenna 32 is not limited to the horizontally polarized wave, and may be any polarized wave orthogonal to the polarized wave mainly transmitted and received by the antenna 31. The antenna 32 is arranged on the in-vehicle surface side of the windshield 12 included in the front region, and is arranged in the central region.

The antenna 33 is a horizontally polarized wave antenna that mainly transmits and receives a horizontally polarized wave that is a polarized wave mainly transmitted and received by the antenna 32. The polarized wave mainly transmitted and received by the antenna 33 may be the same polarized wave as the polarized wave mainly transmitted and received by the antenna 32. The antenna 33 is arranged on the in-vehicle surface side of the windshield 12 included in the front region, and is arranged in the central region.

The antenna 34 is a vertically polarized wave antenna that mainly transmits and receives the vertically polarized wave that is a polarized wave mainly transmitted and received by the antenna 32. The polarized wave mainly transmitted and received by the antenna 34 may be the same polarized wave as the polarized wave mainly transmitted and received by the antenna 31. The antenna 34 is arranged on the in-vehicle surface side of the windshield 12 included in the front region, and is arranged in the second peripheral region. The antenna 34 is arranged close to a pillar 11wc (A pillar 11wc) included in the metal body 11 of the vehicle 10. The “arranged close to the pillar 11wc” means that the antenna 34 is arranged so close not to come into contact with the pillar. In other words, the antenna 34 is arranged close to an edge 11wd of the windshield 12 in the positive direction of the X-axis among edges of the windshield 12 located in the vehicle width direction.

The antenna 34 may be arranged in the first peripheral region. In other words, the antennas 31 and 34 may be arranged in at least one of the first peripheral region and the second peripheral region, and the antennas 32 and 33 may be arranged in the central region. Alternatively, the antennas 32 and 33 may be arranged in at least one of the first peripheral region and the second peripheral region, and the antennas 31 and 34 may be arranged in the central region. Here, the antenna 31 serving as the first antenna and the antenna 34 serving as the third antenna are defined as a first antenna group, and the antenna 32 serving as the second antenna and the antenna 33 serving as the fourth antenna are defined as a second antenna group. In this case, one of the first antenna group and the second antenna group may be arranged in the central region, and the other may be arranged in at least one of the first peripheral region and the second peripheral region.

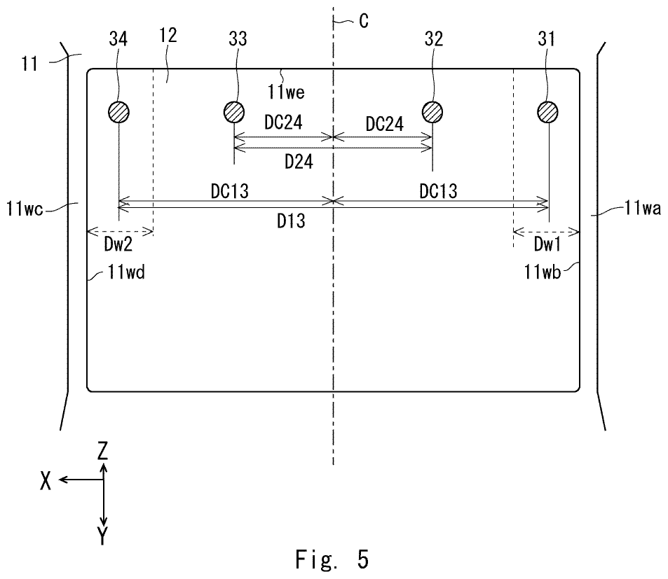

An arrangement example of the antennas 31 to 34 on the windshield 12 will be described below with reference to FIG. 5. FIG. 5 is a plan view of the windshield. The antenna 31 is arranged in the first peripheral region, and is arranged apart from the pillar 11wa of the vehicle 10 within a distance Dw1. The distance Dw1 may be 100 [mm], or 50 [mm]. Further, the antenna 31 is arranged at a position apart by a distance DC13 from the center line C. The antenna 32 is arranged in the central region, and is arranged at a position apart by a distance DC24 from the center line C.

The antenna 33 is arranged in the central region, and is arranged at a position apart by a distance DC24 from the center line C. In other words, the antenna 32 serving as the second antenna and the antenna 33 serving as the fourth antenna are arranged at positions apart by the same distance from the center line C. The antennas 32 and 33 may not be arranged at the position apart by the same distance from the center line C as long as being arranged in the central region. In addition, the antenna 33 is arranged at a position apart by a distance D24 from the antenna 32. The distance D24 may be k₁×λ/2 or more, where X is defined as a wavelength in air of the radio waves of the frequency transmitted and received by the MIMO antenna 30 and k₁ is defined as a wavelength shortening rate of the dielectric to which the antennas 32 and 33 are attached. When the distance D24, which is twice the distance DC24, is set to k₁×λ/2 or more, a correlation of the antennas can be prevented, that is, interference between the same polarized waves in the antennas 32 and 33 can be prevented, and thus the antenna gain and the communication capacity can be improved.

The antenna 34 is arranged in the second peripheral region, and is arranged apart from the pillar 11wc of the vehicle 10 within a distance Dw2. The distance Dw2 may be 100 [mm], or 50 [mm]. Further, the distance Dw2 may be equal to or different from the value of the distance Dw1. The antenna 34 is arranged at a position apart by a distance DC13 from the center line C. In Example 3, the antenna 31 serving as the first antenna and the antenna 34 serving as the third antenna are arranged at positions apart by the same distance from the center line C. The antennas 31 and 34 may not be arranged at the positions apart by the same distance from the center line C as long as one of the antennas 31 and 34 may be arranged in the first peripheral region and the other may be arranged in the second peripheral region. The antenna 34 is arranged at a position apart by a distance D13 from the antenna 31. When the distance D13 may be k₂×λ/2 or more, where λ is defined as a wavelength in air of the radio waves of the frequency transmitted and received by the MIMO antenna 30 and k₂ is defined as a wavelength shortening rate of the dielectric to which the antennas 31 and 34 are attached, a correlation of the antennas can be prevented, that is, interference between the same polarized waves in the antennas 31 and 34 can be prevented, and thus the antenna gain and the communication capacity can be improved. In Example 3, since the antennas 31 to 34 are attached to the windshield 12 having the same dielectric, k₁ and k₂ have the same value, and thus the distance D13 and the distance D24 may be k₁×λ/2 or more. Furthermore, the distance between the antennas adjacent to each other (for example, the distance between the antenna 31 and the antenna 32) may be k₁×λ/2 or more.

A communication capacity of the antenna system for vehicle 120 will be described below. In order to evaluate the communication capacity of the antenna system for vehicle 120, the communication capacity of the antenna system for vehicle 120 was used with respect to the communication capacity of a configuration in which all the antennas of the antenna system for vehicle 120 are replaced with vertically polarized wave antennas. Further, in order to evaluate the communication capacity of the antenna system for vehicle 120, the communication capacity of the antenna system for vehicle 120 was used with respect to the communication capacity of a configuration in which all the antennas of the antenna system for vehicle 120 are replaced with horizontally polarized wave antennas.

In the following description, the configuration in which all the antennas of the antenna system for vehicle are replaced with vertically polarized wave antennas is referred to as “default configuration 1”, and the configuration in which all the antennas of the antenna system for vehicle are replaced with horizontally polarized wave antennas is referred to as “default configuration 2”. In other words, default configuration 1 is a configuration in which the arrangement of the antennas included in the antenna system for vehicle is the same as in the antenna system for vehicle, but the antennas 32 and 33 are replaced with vertically polarized wave antennas. In addition, default configuration 2 is a configuration in which the arrangement of the antennas included in the antenna system for vehicle is the same as in the antenna system for vehicle, but the antennas 31 and 34 are replaced with horizontally polarized wave antennas.

For the antenna system for vehicle 120, default configuration 1, and default configuration 2, the following settings were made.
(Center) frequency transmitted and received by the MIMO antenna 30:3.7 [GHz]
Bandwidth of the frequency transmitted and received by the MIMO antenna 30: 100 [MHz]
Vehicle width W: 1710 [mm]
Distance D24: 345 [mm]
Distance D13: 1530 [mm]

The vehicles 10 having the antenna system for vehicle 120, default configuration 1, and default configuration 2 are travelled on a route with no line of sight to a base station and a route with line of sight to the base station for the same distance in a simulation, and thus a communication capacity (unit: [bit/s/Hz]) of each of the antenna system for vehicle 120, default configuration 1, and default configuration 2 was calculated. Then, the communication capacity of the antenna system for vehicle 120 was calculated as a relative value when the communication capacity of default configuration 1 and default configuration 2 was assumed to be 100[%]. As a result of calculating the communication capacity, the communication capacity of the antenna system for vehicle 120 was 117[%] relative to that of default configuration 1. Further, the communication capacity of the antenna system for vehicle 120 was 124[%] relative to that of default configuration 2.

As described above, in the antenna system for vehicle 120, the antennas 31 to 34 included in the MIMO antenna 30 are configured as vertically polarized wave antennas or horizontally polarized wave antennas, and are dispersedly arranged in the vehicle 10. The antenna system for vehicle 120 according to Example 3 can improve the communication capacity compared to the case where the antenna system for vehicle is configured as default configuration 1 in which all the antennas are vertically polarized wave antennas. Furthermore, the antenna system for vehicle 120 according to Example 3 can improve the communication capacity compared to the case where the antenna system for vehicle is configured as default configuration 2 in which all the antennas are horizontally polarized wave antennas.

### Example 4

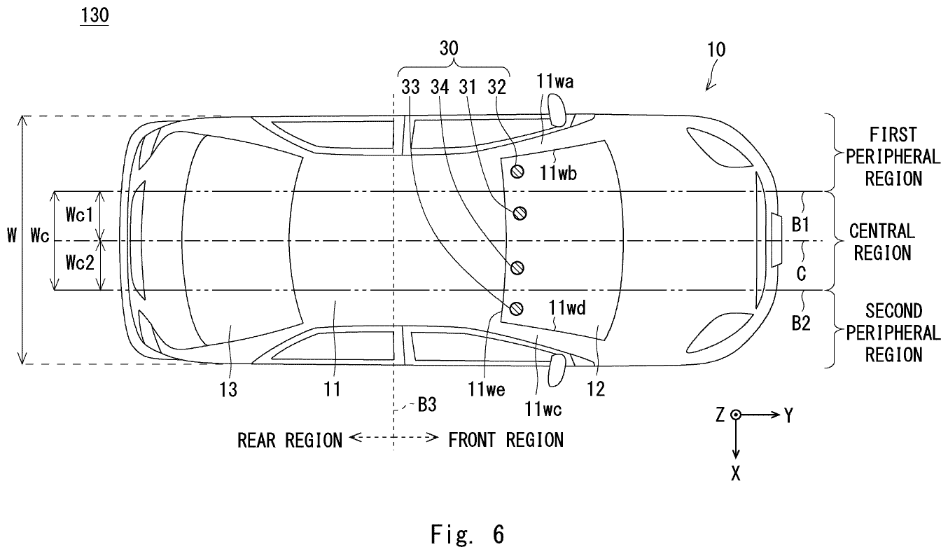

Subsequently, a configuration of an antenna system for vehicle 130 according to Example 4 will be described with reference to FIG. 6. FIG. 6 is a view showing a vehicle of the antenna system for vehicle according to Example 4 as viewed from above. The antenna system for vehicle 130 includes the vehicle 10 and the MIMO antenna 30 as in Example 3. Example 4 is a specific example of Example 1, and has a configuration in which the MIMO antenna 30 is arranged in the front region as in Example 3. In the following examples, the antenna system for vehicle also includes the vehicle 10 and the MIMO antenna 30, and thus the description common to Example 3 will not be given as appropriate.

In Example 4, the positions where the antennas 31 and 34 serving as the vertically polarized wave antennas in Example 3 are arranged are replaced with the positions where the antennas 32 and 33 serving as the horizontally polarized wave antennas are arranged. In the following examples including Example 4, configuration examples of the antennas 31 to 34 are also basically the same as in Example 3 except that arrangement positions of the antennas are different from those in the other examples. Therefore, the description common to Example 3 will not be given below as appropriate.

The antenna 31 is arranged at the position of the antenna 32 according to Example 3. The antenna 31 is arranged on the in-vehicle surface side of the windshield 12 included in the front region, and is arranged in the central region. The antenna 32 is arranged at the position of the antenna 31 according to Example 3. The antenna 32 is arranged on the in-vehicle surface side of the windshield 12 included in the front region, and is arranged in the first peripheral region. The antenna 32 is arranged close to the pillar 11wa included in the metal body 11 of the vehicle 10.

The antenna 33 is arranged at the position of the antenna 34 according to Example 3. The antenna 33 is arranged on the in-vehicle surface side of the windshield 12 included in the front region, and is arranged in the second peripheral region. The antenna 33 is arranged close to the pillar 11wc included in the metal body 11 of the vehicle 10. The antenna 34 is arranged at the position of the antenna 33 according to Example 3. The antenna 34 is arranged on the in-vehicle surface side of the windshield 12 included in the front region, and is arranged in the central region.

Although not shown, even in Example 4, the antenna 31 serving as the first antenna and the antenna 34 serving as the third antenna are arranged at positions apart by the same distance from the center line C, and the antenna 32 serving as the second antenna and the antenna 33 serving as the fourth antenna are arranged at positions apart by the same distance from the center line C. The antennas 31 and 34 may not be arranged at the positions apart by the same distance from the center line C, and the antennas 32 and 33 may not be arranged at the positions apart by the same distance from the center line C. Further, the distance D24 between the antennas 32 and 33 and the distance D13 between the antennas 31 and 34 may be set to k₁×λ/2 or more in order to prevent the correlation of the antennas and improve the antenna gain and the communication capacity, and the distance between the antennas adjacent to each other may be k₁×λ/2 or more.

A communication capacity of the antenna system for vehicle 130 will be described below. The evaluation method is the same as in Example 3, and thus will not be described. For the antenna system for vehicle 130, default configuration 1, and default configuration 2, the following settings were made. The frequency transmitted and received by the MIMO antenna 30, the bandwidth of the frequency, and the vehicle width W are the same as in the following examples including Example 5, and thus will not be described below. (Center) frequency transmitted and received by the MIMO antenna 30: 3.7 [GHz]
Bandwidth of the frequency transmitted and received by the MIMO antenna 30: 100 [MHz]
Vehicle width W: 1710 [mm]
Distance D24: 1530 [mm]
Distance D13: 345 [mm]

As a result of calculation of the communication capacity, the communication capacity of the antenna system for vehicle 130 was 124[%] relative to that of default configuration 1. In addition, the communication capacity of the antenna system for vehicle 130 was 131[%] relative to that of default configuration 2.

As described above, the antenna system for vehicle 130 has a configuration different from that of the antenna system for vehicle 120 according to Example 3 in terms of the arrangement of the antennas 31 to 34. As described above, the antenna system for vehicle 130 according to Example 4 can improve the communication capacity compared to default configuration 1 and default configuration 2.

### Example 5

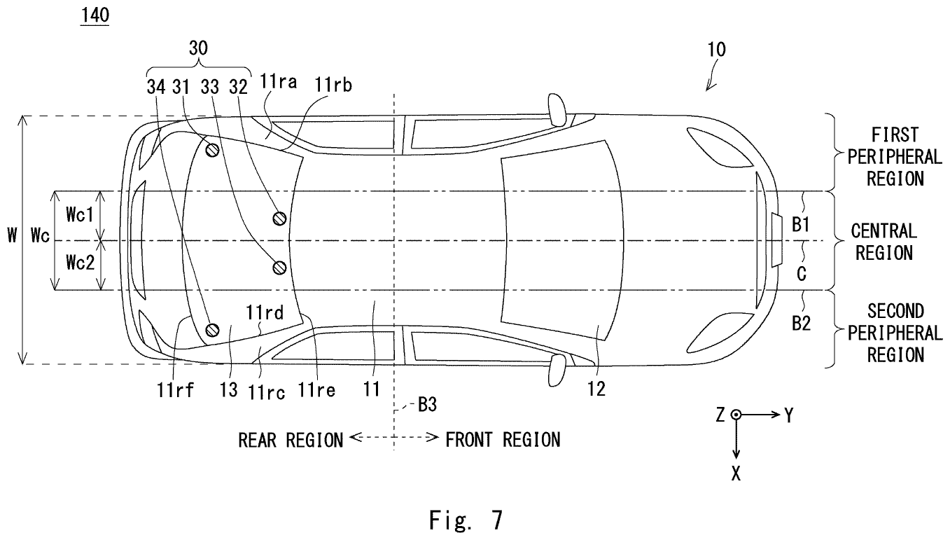

Subsequently, a configuration of an antenna system for vehicle 140 according to Example 5 will be described with reference to FIG. 7. FIG. 7 is a view showing a vehicle of the antenna system for vehicle according to Example 5 as viewed from above. Example 5 is a specific example of Example 1, and has a configuration in which the MIMO antenna 30 is arranged in the rear region.

The antennas 31 to 34 are arranged on the rear window 13 included in the rear region. The antenna 31 is arranged on the rear window 13 included in the rear region, and is arranged in the first peripheral region. The antenna 31 is arranged close to a pillar 11ra (C pillar 11ra) included in the metal body 11 of the vehicle 10. In other words, the antenna 31 is arranged close to an edge 11rb of the rear window 13 in the negative direction of the X-axis. The “arranged close to the pillar 11ra” means that the conductor of the antenna 31 is arranged so close not to come into contact with the pillar. Further, the antenna 31 is arranged close to a lower edge 11rf of the rear window 13.

The antennas 32 and 33 are arranged on the in-vehicle surface side of the rear window 13 included in the rear region, and are arranged in the central region. The antennas 32 and 33 are arranged close to an upper edge 11re of the rear window 13, for example.

The antenna 34 is arranged on the in-vehicle surface side of the rear window 13 included in the rear region, and is arranged in the second peripheral region. The antenna 34 is arranged close to a pillar 11rc (C pillar 11rc) included in the metal body 11 of the vehicle 10. In other words, the antenna 34 is arranged close to an edge 11rd of the rear window 13 in the positive direction of the X-axis among edges of the rear window 13 located in the vehicle width direction. The “arranged close to the pillar 11rc” means that the conductor of the antenna 34 is arranged so close not to come into contact with the pillar. Further, the antenna 34 is arranged close to the lower edge 11rf of the rear window 13.

The antenna 34 may be arranged in the first peripheral region. In other words, the antennas 31 and 34 may be arranged in at least one of the first peripheral region and the second peripheral region, and the antennas 32 and 33 may be arranged in the central region. Alternatively, the antennas 32 and 33 may be arrange in at least one of the first peripheral region and the second peripheral region, and the antennas 31 and 34 may be arranged in the central region. In other words, one of the first antenna group including the antennas 31 and 34 and the second antenna group including the antennas 32 and 33 may be arranged in the central region, and the other may be arranged in at least one of the first peripheral region and the second peripheral region.

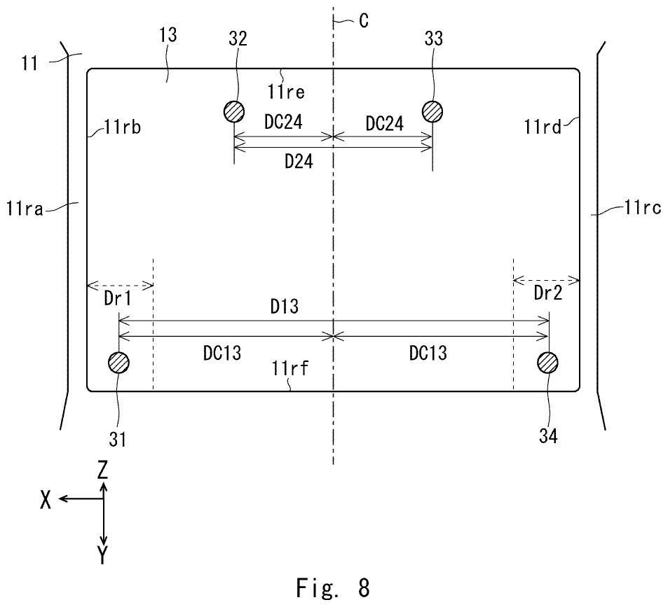

An arrangement example of the antennas 31 to 34 on the rear window 13 will be described below with reference to FIG. 8. FIG. 8 is a plan view of the rear window. The antenna 31 is arranged close to the lower edge 11rf of the rear window 13. The antenna 31 is arranged in the first peripheral region, and is arranged apart from the pillar 11ra of the vehicle 10 within a distance Dr1. The distance Dr1 may be 100 [mm], or 50 [mm]. The distance Dr1 may have the same value as at least one of the distance Dw1 and the distance Dw2, or may have a value different from the distance Dw1 and the distance Dw2. The antenna 31 is arranged at a position apart by a distance DC13 from the center line C.

The antenna 32 is arranged close to the upper edge 11re of the rear window 13. The antenna 32 is arranged in the central region, and is arranged at a position apart by a distance DC24 from the center line C.

The antenna 33 is arranged close to the upper edge 11re of the rear window 13. The antenna 33 is arranged in the central region, and is arranged at a position apart by a distance D24, which is the same distance as the distance from the center line C to the antenna 32, from the center line C. The distance between the antenna 33 and the center line C may be different from the distance between the antenna 32 and the center line C. In addition, the antenna 33 is arranged at a position apart by the distance D24 from the antenna 32. The distance D24 may be k₁×λ/2 or more as in Example 3.

The antenna 34 is arranged close to the lower edge 11rf of the rear window 13. The antenna 34 is arranged in the second peripheral region, and is arranged apart from the pillar 11rc of the vehicle 10 within a distance Dr2. The distance Dr2 may be 100 [mm], or 50 [mm]. The distance Dr2 may have the same value as at least one of the distance Dr1, the distance Dw1, and the distance Dw2, or may have a value different from the distance Dr1, the distance Dw1, and the distance Dw2. The antenna 34 is arranged at a position apart by a distance DC13, which is the same distance as the distance from the center line C to the antenna 31, from the center line C. The distance between the antenna 34 and the center line C may be different from the distance between the antenna 31 and the center line C. The antenna 34 is arranged at a position apart by the distance D13 from the antenna 31. The distance D24 may be k₂×λ/2 or more as in Example 3. Also in Example 5, since the antennas 31 to 34 are attached to the rear window 13 having the same dielectric, k₁ and k₂ have the same value.

A communication capacity of the antenna system for vehicle 140 will be described below. The evaluation method is the same as in Example 3, and thus will not be described. For the antenna system for vehicle 140, default configuration 1, and default configuration 2, the following settings were made.
Distance D24: 700 [mm]
Distance D13: 1470 [mm]

As a result of calculation of the communication capacity, the communication capacity of the antenna system for vehicle 140 was 122[%] relative to that of default configuration 1. In addition, the communication capacity of the antenna system for vehicle 140 was 117[%] relative to that of default configuration 2.

As described above, even when the MIMO antenna 30 is arranged on the rear window 13 included in the rear region, the antenna system for vehicle 140 according to Example 5 can improve the communication capacity compared to default configuration 1 and default configuration 2.

### Example 6

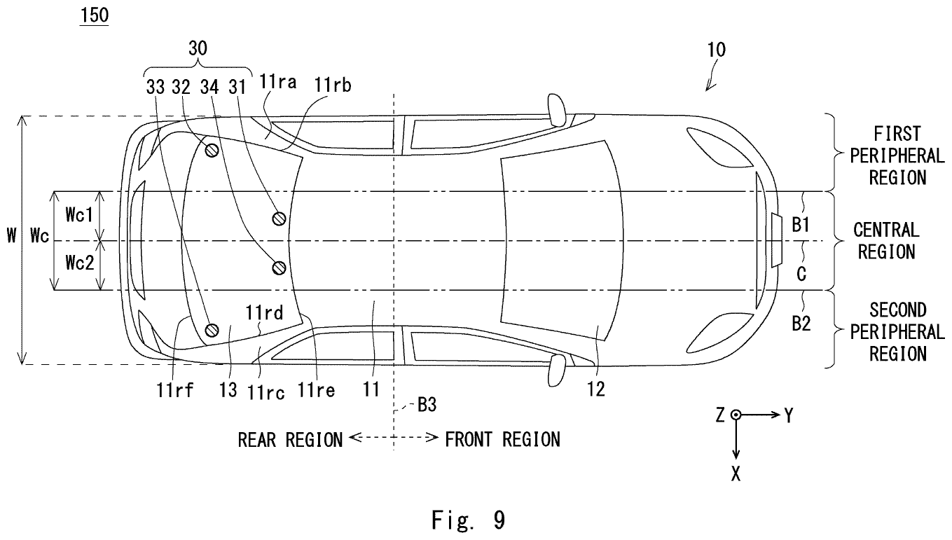

Subsequently, a configuration of an antenna system for vehicle 150 according to Example 6 will be described with reference to FIG. 9. FIG. 9 is a view showing a vehicle of the antenna system for vehicle according to Example 6 as viewed from above. Example 6 is a specific example of Example 1. Further, Example 6 has a configuration in which the positions where the antennas 31 and 34 serving as the vertically polarized wave antennas in Example 5 are arranged are replaced with the positions where the antennas 32 and 33 serving as the horizontally polarized wave antennas are arranged.

The antenna 31 is arranged at the position of the antenna 32 according to Example 5. The antenna 31 is arranged on the in-vehicle surface side of the rear window 13 included in the rear region, and is arranged in the central region. The antenna 31 is arranged close to an upper edge 11re of the rear window 13.

The antenna 32 is arranged at the position of the antenna 31 according to Example 5. The antenna 32 is arranged on the in-vehicle surface side of the rear window 13 included in the rear region, and is arranged in the first peripheral region. The antenna 32 is arranged close to the pillar 11ra included in the metal body 11 of the vehicle 10. Further, the antenna 32 is arranged close to a lower edge 11rf of the rear window 13.

The antenna 33 is arranged at the position of the antenna 34 according to Example 5. The antenna 33 is arranged on the in-vehicle surface side of the rear window 13 included in the rear region, and is arranged in the second peripheral region. The antenna 33 is arranged close to the pillar 11rc included in the metal body 11 of the vehicle 10. Further, the antenna 33 is arranged close to the lower edge 11rf of the rear window 13.

The antenna 34 is arranged at the position of the antenna 33 according to Example 5. The antenna 34 is arranged on the in-vehicle surface side of the rear window 13 included in the rear region, and is arranged in the central region. The antenna 34 is arranged close to the upper edge 11re of the rear window 13.

Although not shown, even in the following examples including Example 6, the antenna 31 serving as the first antenna and the antenna 34 serving as the third antenna are arranged at positions apart by the same distance from the center line C. In addition, the antenna 32 serving as the second antenna and the antenna 33 serving as the fourth antenna are arranged at positions apart by the same distance from the center line C. Further, the distance D24 between the antennas 32 and 33 and the distance D13 between the antennas 31 and 34 may be set to k₁×λ/2 or more in order to prevent the correlation of the antennas and improve the antenna gain and the communication capacity, and the distance between the antennas adjacent to each other may be k₁×λ/2 or more.

A communication capacity of the antenna system for vehicle 150 will be described below. The evaluation method is the same as in Example 3, and thus will not be described. For the antenna system for vehicle 150, default configuration 1, and default configuration 2, the following settings were made.
Distance D24: 1470 [mm]
Distance D13: 700 [mm]

As a result of calculation of the communication capacity, the communication capacity of the antenna system for vehicle 150 was 124[%] relative to that of default configuration 1. In addition, the communication capacity of the antenna system for vehicle 150 was 119[%] relative to that of default configuration 2.

As described above, the antenna system for vehicle 150 according to Example 6 can improve the communication capacity compared to default configuration 1 and default configuration 2.

### Example 7

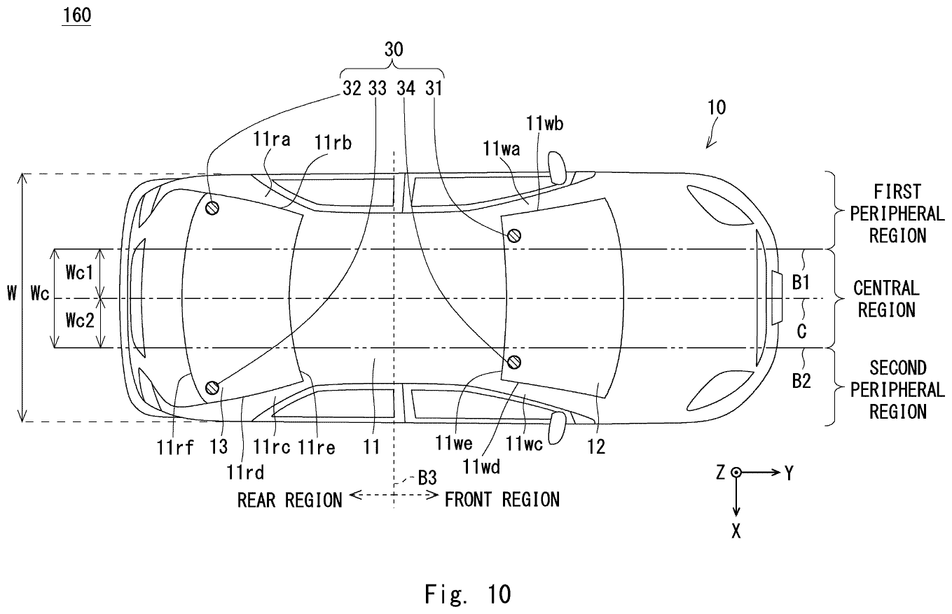

Subsequently, a configuration of an antenna system for vehicle 160 according to Example 7 will be described with reference to FIG. 10. FIG. 10 is a view showing a vehicle of the antenna system for vehicle according to Example 7 as viewed from above. Example 7 is a specific example of Example 2. Example 7 has a configuration in which the antennas 31 and 34 are arranged at the same positions as in Example 3, and the antennas 32 and 33 are arranged at the same positions as in Example 6. Example 7 has a configuration in which the first antenna group including the antenna 31 serving as the first antenna and the antenna 34 serving as the third antenna is arranged in the front region and the second antenna group including the antenna 32 serving as the second antenna and the antenna 33 serving as the fourth antenna is arranged in the rear region. Furthermore, Example 7 has a configuration in which the first antenna group is arranged on the windshield and the second antenna group is arranged on the rear window.

The antenna 31 is arranged at the same position as the antenna 31 according to Example 3. The antenna 31 is arranged on the in-vehicle surface side of the windshield 12 included in the front region, and is arranged in the first peripheral region. The antenna 31 is arranged close to the pillar 11wa of the vehicle 10. In addition, the antenna 31 is arranged close to the upper edge 11we of the windshield 12.

The antenna 32 is arranged at the same position as the antenna 32 according to Example 6. The antenna 32 is arranged on the in-vehicle surface side of the rear window 13 included in the rear region, and is arranged in the first peripheral region. The antenna 32 is arranged close to the pillar 11ra of the vehicle 10. In addition, the antenna 32 is arranged close to the lower edge 11rf of the rear window 13.

The antenna 33 is arranged at the same position as the antenna 33 according to Example 6. The antenna 33 is arranged on the in-vehicle surface side of the rear window 13 included in the rear region, and is arranged in the second peripheral region. The antenna 33 is arranged close to the pillar 11rc of the vehicle 10. In addition, the antenna 33 is arranged close to the lower edge 11rf of the rear window 13.

The antenna 34 is arranged at the same position as the antenna 34 according to Example 3. The antenna 34 is arranged on the in-vehicle surface side of the windshield 12 included in the front region, and is arranged in the second peripheral region. The antenna 34 is arranged close to the pillar 11wc of the vehicle 10. In addition, the antenna 34 is arranged close to the upper edge 11we of the windshield 12.

A communication capacity of the antenna system for vehicle 160 will be described below. The evaluation method is the same as in Example 3, and thus will not be described. For the antenna system for vehicle 160, default configuration 1, and default configuration 2, the following settings were made.
Distance D24: 1530 [mm]
Distance D13. 1470 [mm]

As a result of calculation of the communication capacity, the communication capacity of the antenna system for vehicle 160 was 113[%] relative to that of default configuration 1. In addition, the communication capacity of the antenna system for vehicle 160 was 124[%] relative to that of default configuration 2.

As described above, the antenna system for vehicle 160 according to Example 7 can improve the communication capacity compared to default configuration 1 and default configuration 2.

### Example 8

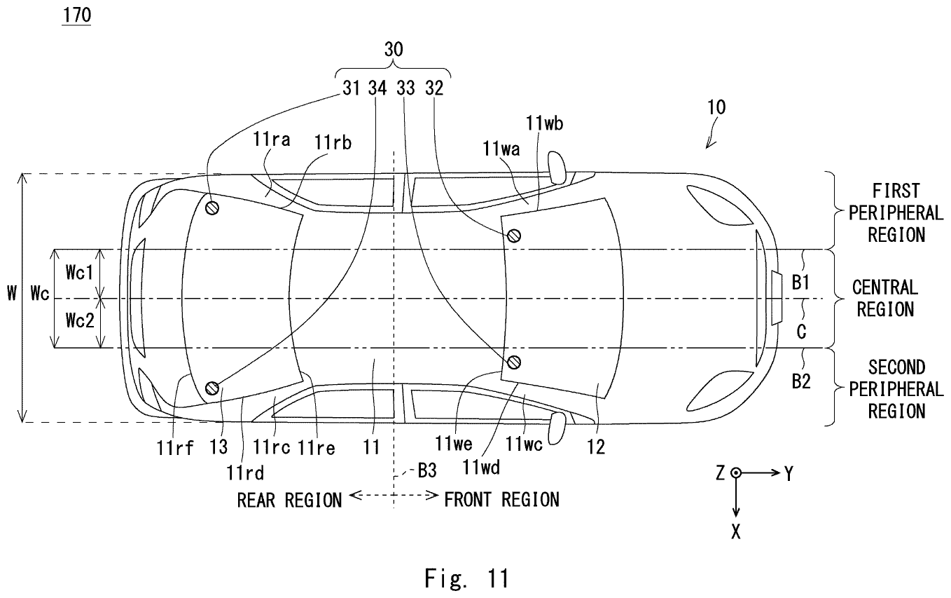

Subsequently, a configuration of an antenna system for vehicle 170 according to Example 8 will be described with reference to FIG. 11. FIG. 11 is a view showing a vehicle of the antenna system for vehicle according to Example 8 as viewed from above. Example 8 is a specific example of Example 2. Example 8 has a configuration in which the positions where the antennas 31 and 34 serving as the vertically polarized wave antennas in Example 7 are arranged are replaced with the positions where the antennas 32 and 33 serving as the horizontally polarized wave antennas are arranged. Example 8 has a configuration in which the first antenna group including the antenna 31 serving as the first antenna and the antenna 34 serving as the third antenna is arranged in the rear region and the second antenna group including the antenna 32 serving as the second antenna and the antenna 33 serving as the fourth antenna is arranged in the front region. Furthermore, Example 8 has a configuration in which the first antenna group is arranged on the rear window and the second antenna group is arranged on the windshield.

The antenna 31 is arranged at the same position as the antenna 32 according to Example 7. The antenna 31 is arranged on the in-vehicle surface side of the rear window 13 included in the rear region, and is arranged in the first peripheral region. The antenna 31 is arranged close to the pillar 11ra of the vehicle 10. In addition, the antenna 31 is arranged close to the lower edge 11rf of the rear window 13.

The antenna 32 is arranged at the same position as the antenna 31 according to Example 7. The antenna 32 is arranged on the in-vehicle surface side of the windshield 12 included in the front region, and is arranged in the first peripheral region. The antenna 32 is arranged close to the pillar 11wa of the vehicle 10. In addition, the antenna 32 is arranged close to the upper edge 11we of the windshield 12.

The antenna 33 is arranged at the same position as the antenna 34 according to Example 7. The antenna 33 is arranged on the in-vehicle surface side of the windshield 12 included in the front region, and is arranged in the second peripheral region. The antenna 33 is arranged close to the pillar 11wc of the vehicle 10. In addition, the antenna 33 is arranged close to the upper edge 11we of the windshield 12.

The antenna 34 is arranged at the same position as the antenna 33 according to Example 7. The antenna 34 is arranged on the in-vehicle surface side of the rear window 13 included in the rear region, and is arranged in the second peripheral region. The antenna 34 is arranged close to the pillar 11rc of the vehicle 10. In addition, the antenna 34 is arranged close to the lower edge 11rf of the rear window 13.

A communication capacity of the antenna system for vehicle 170 will be described below. The evaluation method is the same as in Example 3, and thus will not be described. For the antenna system for vehicle 170, default configuration 1, and default configuration 2, the following settings were made.
Distance D24: 1470 [mm]
Distance D13: 1530 [mm]

As a result of calculation of the communication capacity, the communication capacity of the antenna system for vehicle 170 was 105[%] relative to that of default configuration 1. In addition, the communication capacity of the antenna system for vehicle 170 was 115[%] relative to that of default configuration 2.

As described above, the antenna system for vehicle 170 according to Example 8 can improve the communication capacity compared to default configuration 1 and default configuration 2. Example 9

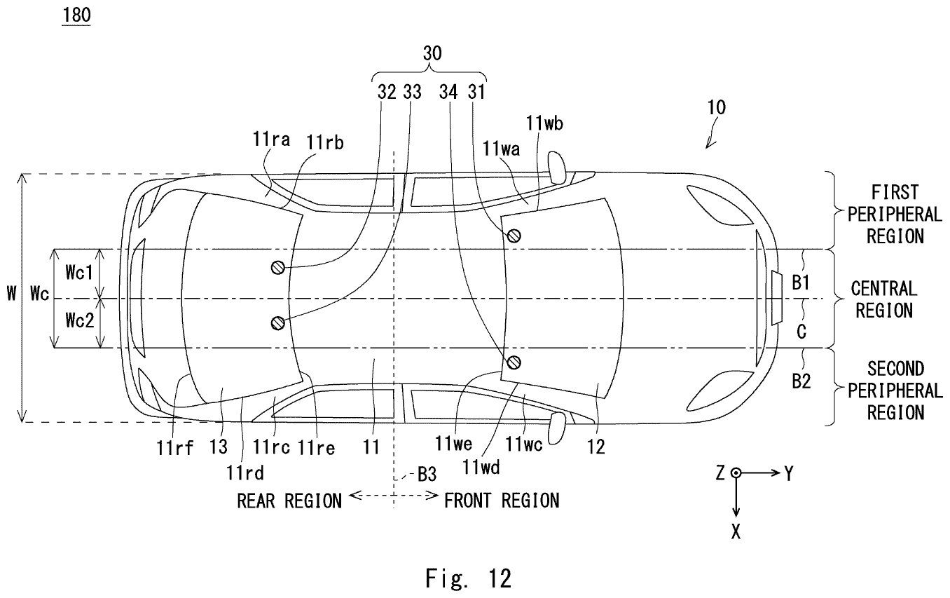

Subsequently, a configuration of an antenna system for vehicle 180 according to Example 9 will be described with reference to FIG. 12. FIG. 12 is a view showing a vehicle of the antenna system for vehicle according to Example 9 as viewed from above. Example 9 is a specific example of Example 1, and is a specific example of Example 2. Example 9 has a configuration in which the antennas 31 and 34 are arranged at the same positions as in Example 3, and the antennas 32 and 33 are arranged at the same positions as in Example 5. Example 9 has a configuration in which the first antenna group including the antenna 31 serving as the first antenna and the antenna 34 serving as the third antenna is arranged in the front region and the second antenna group including the antenna 32 serving as the second antenna and the antenna 33 serving as the fourth antenna is arranged in the rear region. Furthermore, Example 9 has a configuration in which the first antenna group is arranged in at least one of the first peripheral region and the second peripheral region and the second antenna group is arranged in the central region.

The antenna 31 is arranged at the same position as the antenna 31 according to Example 3. The antenna 31 is arranged on the in-vehicle surface side of the windshield 12 included in the front region, and is arranged in the first peripheral region. The antenna 31 is arranged close to the pillar 11wa of the vehicle 10. In addition, the antenna 31 is arranged close to the upper edge 11we of the windshield 12.

The antenna 32 is arranged at the same position as the antenna 32 according to Example 5. The antenna 32 is arranged on the in-vehicle surface side of the rear window 13 included in the rear region, and is arranged in the central region. The antenna 32 is arranged close to the upper edge 11re of the rear window 13.

The antenna 33 is arranged at the same position as the antenna 33 according to Example 5. The antenna 33 is arranged on the in-vehicle surface side of the rear window 13 included in the rear region, and is arranged in the central region. The antenna 33 is arranged close to the upper edge 11re of the rear window 13.

The antenna 34 is arranged at the same position as the antenna 34 according to Example 3. The antenna 34 is arranged on the in-vehicle surface side of the windshield 12 included in the front region, and is arranged in the second peripheral region. The antenna 34 is arranged close to the pillar 11wc of the vehicle 10. In addition, the antenna 33 is arranged close to the upper edge 11we of the windshield 12.

A communication capacity of the antenna system for vehicle 180 will be described below. The evaluation method is the same as in Example 3, and thus will not be described. For the antenna system for vehicle 180, default configuration 1, and default configuration 2, the following settings were made.
Distance D24: 700 [mm]
Distance D13: 1470 [mm]

As a result of calculation of the communication capacity, the communication capacity of the antenna system for vehicle 180 was 109[%] relative to that of default configuration 1. In addition, the communication capacity of the antenna system for vehicle 180 was 125[%] relative to that of default configuration 2.

As described above, the antenna system for vehicle 180 according to Example 9 can improve the communication capacity compared to default configuration 1 and default configuration 2.

### Example 10

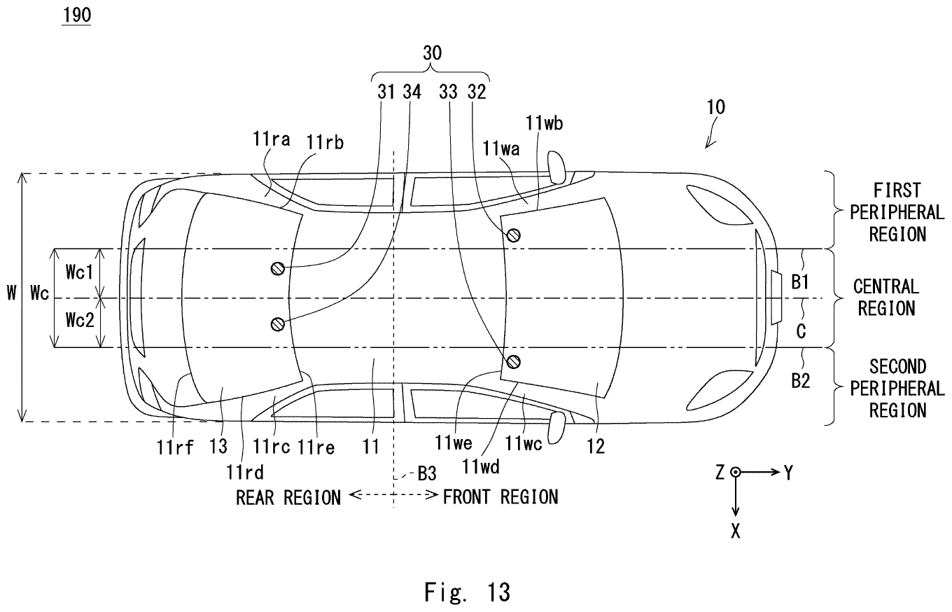

Subsequently, a configuration of an antenna system for vehicle 190 according to Example 10 will be described with reference to FIG. 13. FIG. 13 is a view showing a vehicle of the antenna system for vehicle according to Example 10 as viewed from above. Example 10 is a specific example of Example 1, and is a specific example of Example 2. Example 10 has a configuration in which the positions where the antennas 31 and 34 serving as the vertically polarized wave antennas in Example 9 are arranged are replaced with the positions where the antennas 32 and 33 serving as the horizontally polarized wave antennas are arranged. Example 10 has a configuration in which the first antenna group including the antenna 31 serving as the first antenna and the antenna 34 serving as the third antenna is arranged in the front region and the second antenna group including the antenna 32 serving as the second antenna and the antenna 33 serving as the fourth antenna is arranged in the rear region. Furthermore, Example 10 has a configuration in which the first antenna group is arranged in at least one of the first peripheral region and the second peripheral region and the second antenna group is arranged in the central region.

The antenna 31 is arranged at the same position as the antenna 32 according to Example 9. The antenna 31 is arranged on the in-vehicle surface side of the rear window 13 included in the rear region, and is arranged in the central region. The antenna 31 is arranged close to the upper edge 11re of the edges of the rear window 13.

The antenna 32 is arranged at the same position as the antenna 31 according to Example 9. The antenna 32 is arranged on the in-vehicle surface side of the windshield 12 included in the front region, and is arranged in the first peripheral region. The antenna 32 is arranged close to the pillar 11wa of the vehicle 10. In addition, the antenna 32 is arranged close to the upper edge 11we of the edges of the windshield 12.

The antenna 33 is arranged at the same position as the antenna 34 according to Example 9. The antenna 33 is arranged on the in-vehicle surface side of the windshield 12 included in the front region, and is arranged in the second peripheral region. The antenna 33 is arranged close to the pillar 11wc of the vehicle 10. In addition, the antenna 33 is arranged close to the upper edge 11we of the windshield 12.

The antenna 34 is arranged at the same position as the antenna 33 according to Example 9. The antenna 34 is arranged on the in-vehicle surface side of the rear window 13 included in the rear region, and is arranged in the central region. The antenna 34 is arranged close to the upper edge 11re of the rear window 13.

A communication capacity of the antenna system for vehicle 190 will be described below. The evaluation method is the same as in Example 3, and thus will not be described. For the antenna system for vehicle 190, default configuration 1, and default configuration 2, the following settings were made.
Distance D24: 1470 [mm]
Distance D13: 700 [mm]

As a result of calculation of the communication capacity, the communication capacity of the antenna system for vehicle 190 was 103[%] relative to that of default configuration 1. In addition, the communication capacity of the antenna system for vehicle 190 was 118[%] relative to that of default configuration 2.

As described above, the antenna system for vehicle 190 according to Example 10 can improve the communication capacity compared to default configuration 1 and default configuration 2.

### Example 11

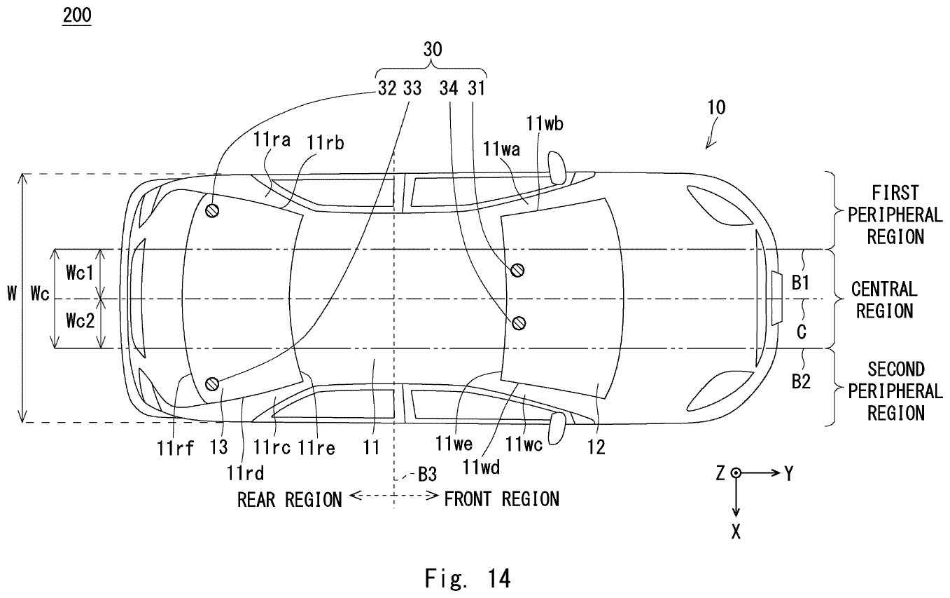

Subsequently, a configuration of an antenna system for vehicle 200 according to Example 11 will be described with reference to FIG. 14. FIG. 14 is a view showing a vehicle of the antenna system for vehicle according to Example 11 as viewed from above. Example 11 is a specific example of Example 1, and is a specific example of Example 2. Example 11 has a configuration in which the antennas 31 and 34 are arranged at the same positions as in Example 4, and the antennas 32 and 33 are arranged at the same positions as in Example 6. Example 11 has a configuration in which the first antenna group including the antenna 31 serving as the first antenna and the antenna 34 serving as the third antenna is arranged in the front region and the second antenna group including the antenna 32 serving as the second antenna and the antenna 33 serving as the fourth antenna is arranged in the rear region. Furthermore, Example 11 has a configuration in which the first antenna group is arranged in the central region, and the second antenna group is arranged in at least one of the first peripheral region and the second peripheral region.

The antenna 31 is arranged at the same position as the antenna 31 according to Example 4. The antenna 31 is arranged on the in-vehicle surface side of the windshield 12 included in the front region, and is arranged in the central region. The antenna 31 is arranged close to the upper edge 11we of the windshield 12.

The antenna 32 is arranged at the same position as the antenna 32 according to Example 6. The antenna 32 is arranged on the in-vehicle surface side of the rear window 13 included in the rear region, and is arranged in the first peripheral region. The antenna 32 is arranged close to the pillar 11ra of the vehicle 10. In addition, the antenna 32 is arranged close to the lower edge 11rf of the edges of the rear window 13.

The antenna 33 is arranged at the same position as the antenna 33 according to Example 6. The antenna 33 is arranged on the in-vehicle surface side of the rear window 13 included in the rear region, and is arranged in the second peripheral region. The antenna 33 is arranged close to the pillar 11rc of the vehicle 10. In addition, the antenna 33 is arranged close to the lower edge 11rf of the edges of the rear window 13.

The antenna 34 is arranged at the same position as the antenna 34 according to Example 4. The antenna 34 is arranged on the in-vehicle surface side of the windshield 12 included in the front region, and is arranged in the central region. The antenna 34 is arranged close to the upper edge 11we of the edges of the windshield 12.

A communication capacity of the antenna system for vehicle 200 will be described below. The evaluation method is the same as in Example 3, and thus will not be described. For the antenna system for vehicle 200, default configuration 1, and default configuration 2, the following settings were made.
Distance D24: 1470 [mm]
Distance D13: 345 [mm]

As a result of calculation of the communication capacity, the communication capacity of the antenna system for vehicle 200 was 122[%] relative to that of default configuration 1. In addition, the communication capacity of the antenna system for vehicle 200 was 131[%] relative to that of default configuration 2.

As described above, the antenna system for vehicle 200 according to Example 11 can improve the communication capacity compared to default configuration 1 and default configuration 2.

### Example 12

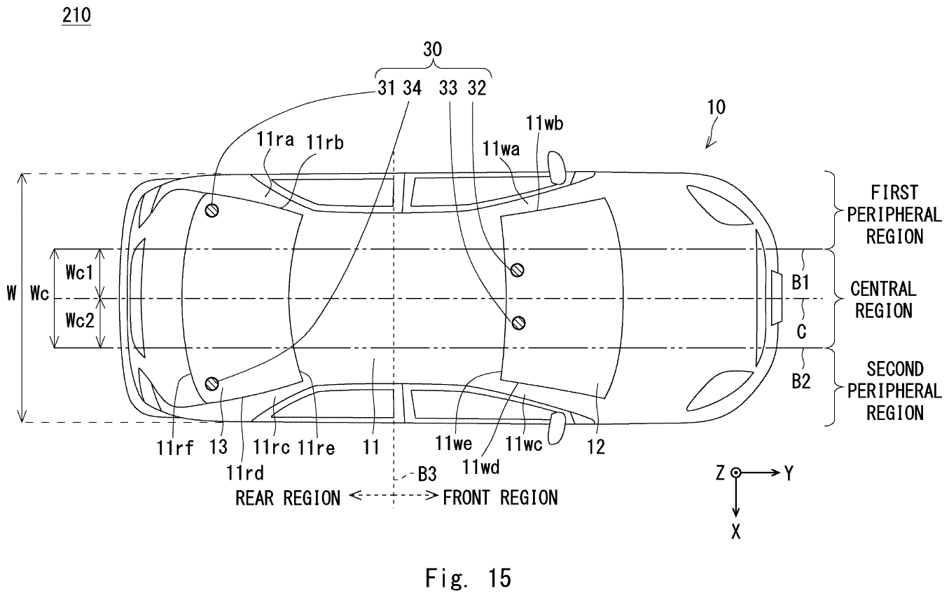

Subsequently, a configuration of an antenna system for vehicle 210 according to Example 12 will be described with reference to FIG. 15. FIG. 15 is a view showing a vehicle of the antenna system for vehicle according to Example 12 as viewed from above. Example 12 is a specific example of Example 1, and is a specific example of Example 2. Example 12 has a configuration in which the positions where the antennas 31 and 34 serving as the vertically polarized wave antennas in Example 11 are arranged are replaced with the positions where the antennas 32 and 33 serving as the horizontally polarized wave antennas are arranged. Example 12 has a configuration in which the first antenna group including the antenna 31 serving as the first antenna and the antenna 34 serving as the third antenna is arranged in the rear region and the second antenna group including the antenna 32 serving as the second antenna and the antenna 33 serving as the fourth antenna is arranged in the front region. Furthermore, Example 12 has a configuration in which the first antenna group is arranged in at least one of the first peripheral region and the second peripheral region and the second antenna group is arranged in the central region.

The antenna 31 is arranged at the same position as the antenna 32 according to Example 11. The antenna 31 is arranged on the in-vehicle surface side of the rear window 13 included in the rear region, and is arranged in the first peripheral region. The antenna 31 is arranged close to the pillar 11ra of the vehicle 10. The antenna 31 is arranged close to the lower edge 11rf of the edges of the rear window 13.

The antenna 32 is arranged at the same position as the antenna 31 according to Example 11. The antenna 32 is arranged on the in-vehicle surface side of the windshield 12 included in the front region, and is arranged in the central region. The antenna 32 is arranged close to the upper edge 11we of the edges of the windshield 12.

The antenna 33 is arranged at the same position as the antenna 34 according to Example 11. The antenna 33 is arranged on the in-vehicle surface side of the windshield 12 included in the front region, and is arranged in the central region. The antenna 33 is arranged close to the upper edge 11we of the edges of the windshield 12.

The antenna 34 is arranged at the same position as the antenna 33 according to Example 11. The antenna 34 is arranged on the in-vehicle surface side of the rear window 13 included in the rear region, and is arranged in the second peripheral region. The antenna 34 is arranged close to the pillar 11rc of the vehicle 10. The antenna 34 is arranged close to the lower edge 11rf of the edges of the rear window 13.

A communication capacity of the antenna system for vehicle 210 will be described below. The evaluation method is the same as in Example 3, and thus will not be described. For the antenna system for vehicle 210, default configuration 1, and default configuration 2, the following settings were made.
Distance D24: 345 [mm]
Distance D13: 1470 [mm]

As a result of calculation of the communication capacity, the communication capacity of the antenna system for vehicle 210 was 106[%] relative to that of default configuration 1. In addition, the communication capacity of the antenna system for vehicle 210 was 114[%] relative to that of default configuration 2.

As described above, the antenna system for vehicle 210 according to Example 12 can improve the communication capacity compared to default configuration 1 and default configuration 2.

### Example 13

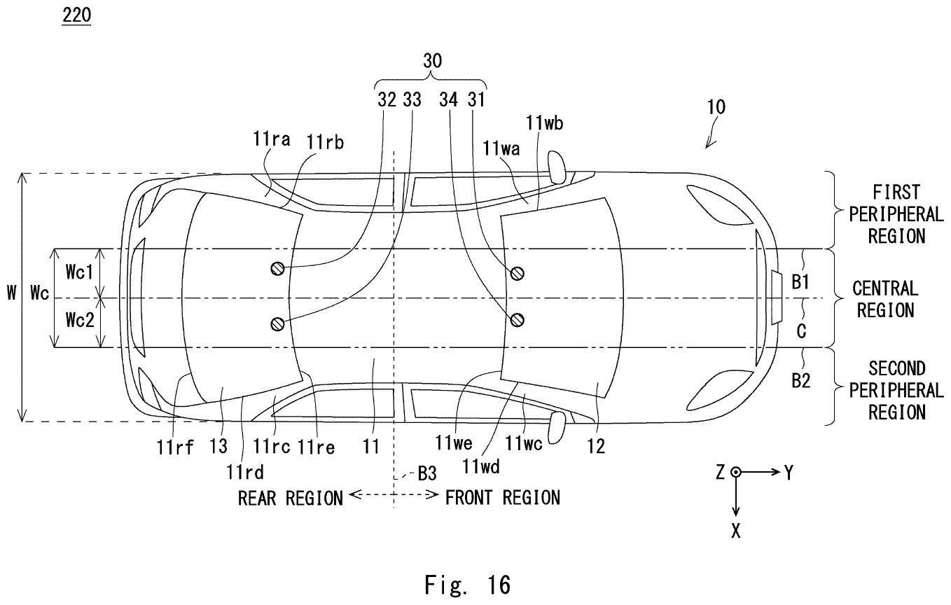

Subsequently, a configuration of an antenna system for vehicle 220 according to Example 13 will be described with reference to FIG. 16. FIG. 16 is a view showing a vehicle of the antenna system for vehicle according to Example 13 as viewed from above. Example 13 is a specific example of Example 2. Example 13 has a configuration in which the antennas 31 and 34 are arranged at the same positions as in Example 4, and the antennas 32 and 33 are arranged at the same positions as in Example 5. Example 13 has a configuration in which the first antenna group including the antenna 31 serving as the first antenna and the antenna 34 serving as the third antenna is arranged in the front region and the second antenna group including the antenna 32 serving as the second antenna and the antenna 33 serving as the fourth antenna is arranged in the rear region.

The antenna 31 is arranged at the same position as the antenna 31 according to Example 4. The antenna 31 is arranged on the in-vehicle surface side of the windshield 12 included in the front region, and is arranged in the central region. The antenna 31 is arranged close to the upper edge 11we of the windshield 12.

The antenna 32 is arranged at the same position as the antenna 32 according to Example 5. The antenna 32 is arranged on the in-vehicle surface side of the rear window 13 included in the rear region, and is arranged in the central region. The antenna 32 is arranged close to the upper edge 11re of the edges of the rear window 13.

The antenna 33 is arranged at the same position as the antenna 33 according to Example 5. The antenna 33 is arranged on the in-vehicle surface side of the rear window 13 included in the rear region, and is arranged in the central region. The antenna 33 is arranged close to the upper edge 11re of the edges of the rear window 13.

The antenna 34 is arranged at the same position as the antenna 34 according to Example 4. The antenna 34 is arranged on the in-vehicle surface side of the windshield 12 included in the front region, and is arranged in the central region. The antenna 34 is arranged close to the upper edge 11we of the edges of the windshield 12.

A communication capacity of the antenna system for vehicle 220 will be described below. The evaluation method is the same as in Example 3, and thus will not be described. For the antenna system for vehicle 220, default configuration 1, and default configuration 2, the following settings were made.
Distance D24: 700 [mm]
Distance D13: 345 [mm]

As a result of calculation of the communication capacity, the communication capacity of the antenna system for vehicle 220 was 122[%] relative to that of default configuration 1. In addition, the communication capacity of the antenna system for vehicle 220 was 132[%] relative to that of default configuration 2.

As described above, the antenna system for vehicle 220 according to Example 13 can improve the communication capacity compared to default configuration 1 and default configuration 2.

### Example 14

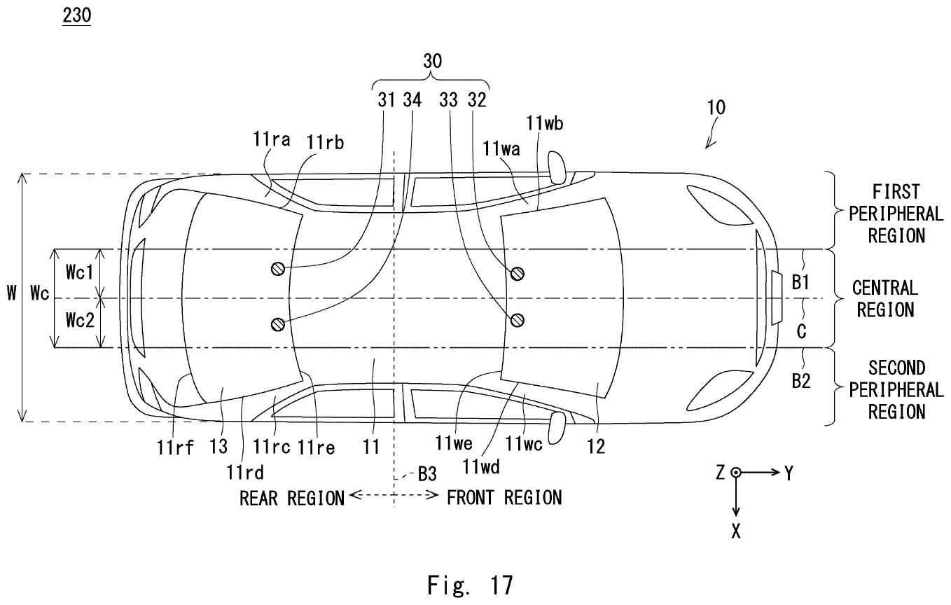

Subsequently, a configuration of an antenna system for vehicle 230 according to Example 14 will be described with reference to FIG. 17. FIG. 17 is a view showing a vehicle of the antenna system for vehicle according to Example 14 as viewed from above. Example 14 is a specific example of Example 2. Example 14 has a configuration in which the positions where the antennas 31 and 34 serving as the vertically polarized wave antennas in Example 13 are arranged are replaced with the positions where the antennas 32 and 33 serving as the horizontally polarized wave antennas are arranged. Example 14 has a configuration in which the first antenna group including the antenna 31 serving as the first antenna and the antenna 34 serving as the third antenna is arranged in the rear region and the second antenna group including the antenna 32 serving as the second antenna and the antenna 33 serving as the fourth antenna is arranged in the front region.

The antenna 31 is arranged at the same position as the antenna 32 according to Example 13. The antenna 31 is arranged on the rear window 13 included in the rear region, and is arranged in the central region. The antenna 31 is arranged close to the upper edge 11re of the edges of the rear window 13.

The antenna 32 is arranged at the same position as the antenna 31 according to Example 13. The antenna 32 is arranged on the in-vehicle surface side of the windshield 12 included in the front region, and is arranged in the central region. The antenna 32 is arranged close to the upper edge 11we of the edges of the windshield 12.

The antenna 33 is arranged at the same position as the antenna 34 according to Example 13. The antenna 33 is arranged on the in-vehicle surface side of the windshield 12 included in the front region, and is arranged in the central region. The antenna 33 is arranged close to the upper edge 11we of the edges of the windshield 12.

The antenna 34 is arranged at the same position as the antenna 33 according to Example 13. The antenna 34 is arranged on the in-vehicle surface side of the rear window 13 included in the rear region, and is arranged in the central region. The antenna 34 is arranged close to the upper edge 11re of the rear window 13.

A communication capacity of the antenna system for vehicle 230 will be described below. The evaluation method is the same as in Example 3, and thus will not be described. For the antenna system for vehicle 230, default configuration 1, and default configuration 2, the following settings were made.
Distance D24: 345 [mm]
Distance D13: 700 [mm]

As a result of calculation of the communication capacity, the communication capacity of the antenna system for vehicle 230 was 109[%] relative to that of default configuration 1. In addition, the communication capacity of the antenna system for vehicle 230 was 118[%] relative to that of default configuration 2.

As described above, the antenna system for vehicle 230 according to Example 14 can improve the communication capacity compared to default configuration 1 and default configuration 2.

Subsequently, evaluation results of the communication capacity of the antenna system for vehicles according to Examples 3 to 14 will be described. Table 1 indicates a summary of relative results of communication capacities of the antenna systems for vehicle according to Examples 3 to 14. Second to fifth columns from a left in Table 1 indicate whether each of the antennas 31 to 34 corresponds to a vertically polarized wave (V polarized wave) or a horizontally polarized wave (H polarized wave). Furthermore, the positions are described in the second to fifth columns where the antennas 31 to 34 are arranged, respectively. WS represents the windshield, RG represents the rear window, and a center represents the central region, a first periphery represents the first peripheral region, and a second periphery represents the second peripheral region. For example, the position where the antenna 31 according to Example 3 is arranged are described as WS and Center in the following table because of being the windshield and the first peripheral region.

TABLE 1
Improvement of communication capacity of antenna system for vehicle according to each Example

| | | | | | Communication capacity | |
|---|---|---|---|---|---|---|
| | Arrangement position | | | | Communication | Communication |
| | Antenna 31 | Antenna 32 | Antenna 33 | Antenna 34 | capacity relative | capacity relative |
| | (V | (H | (H | (V | to default | to default |
| | polarized | polarized | polarized | polarized | configuration 1, | configuration 2, |
| | wave) | wave) | wave) | wave) | [%] | [%] |
| Antenna | WS | WS | WS | WS | 117 | 124 |
| system for | First | Center | Center | Second | | |
| vehicle 120 | periphery | | | periphery | | |
| (Example 3) | | | | | | |
| Antenna | WS | WS | WS | WS | 124 | 131 |
| system for | Center | First | Second | Center | | |
| vehicle 130 | | periphery | periphery | | | |
| (Example 4) | | | | | | |
| Antenna | RG | RG | RG | RG | 122 | 117 |
| system for | First | Center | Center | Second | | |
| vehicle 140 | periphery | | | periphery | | |
| (Example 5) | | | | | | |
| Antenna | RG | RG | RG | RG | 124 | 119 |
| system for | Center | First | Second | Center | | |
| vehicle 150 | | periphery | periphery | | | |
| (Example 6) | | | | | | |
| Antenna | WS | RG | RG | WS | 113 | 124 |
| system for | First | First | Second | Second | | |
| vehicle 160 | periphery | periphery | periphery | periphery | | |
| (Example 7) | | | | | | |
| Antenna | RG | WS | WS | RG | 105 | 115 |
| system for | First | First | Second | Second | | |
| vehicle 170 | periphery | periphery | periphery | periphery | | |
| (Example 8) | | | | | | |
| Antenna | WS | RG | RG | WS | 109 | 125 |
| system for | First | Center | Center | Second | | |
| vehicle 180 | periphery | | | periphery | | |
| (Example 9) | | | | | | |
| Antenna | RG | WS | WS | RG | 103 | 118 |
| system for | Center | First | Second | Center | | |
| vehicle 190 | | periphery | periphery | | | |
| (Example 10) | | | | | | |
| Antenna | WS | RG | RG | WS | 122 | 131 |
| system for | Center | First | Second | Center | | |
| vehicle 200 | | periphery | periphery | | | |
| (Example 11) | | | | | | |
| Antenna | RG | WS | WS | RG | 106 | 114 |
| system for | First | Center | Center | Second | | |
| vehicle 210 | periphery | | | periphery | | |
| (Example 12) | | | | | | |
| Antenna | WS | RG | RG | WS | 122 | 132 |
| system for | Center | Center | Center | Center | | |
| vehicle 220 | | | | | | |
| (Example 13) | | | | | | |
| Antenna | RG | WS | WS | RG | 109 | 118 |
| system for | Center | Center | Center | Center | | |
| vehicle 230 | | | | | | |
| (Example 14) | | | | | | |

As indicated in Table 1, all of the antenna systems for vehicle 120 to 230 had a communication capacity exceeding 100[%] relative to default configuration 1 and default configuration 2. Therefore, the antenna systems for vehicle 120 to 230 can improve the communication capacity relative to default configuration 1 in which all antennas are vertically polarized wave antennas and default configuration 2 in which all antennas are horizontally polarized wave antennas.

In addition, the antenna systems for vehicle 120 to 230 are specific examples of the antenna systems for vehicle according to Examples 1 and 2. Therefore, the antenna system for vehicle according to the embodiment is configured as in Example 1 in which (1) one of the first antenna and the second antenna is arranged in the central region and the other is arranged in the first peripheral region or the second peripheral region, and thus the communication capacity can be improved. In addition, the antenna system for vehicle according to the embodiment is configured as in Example 2 in which (2) one of the first antenna and the second antenna is arranged in the first region and the other is arranged in the second region, and thus the communication capacity can be improved. Furthermore, even when the antenna system for vehicle according to the embodiment is configured in combination of Examples 1 and 2, the communication capacity can be improved. In other words, the antenna system for vehicle according to the embodiment is configured in which the first antenna and the second antenna are arranged based on at least one of (1) and (2) described above, and thus the communication capacity can be improved.

Next, a comparison result of the communication capacities of the antenna systems for vehicle 120 to 230 will be described. In order to compare the communication capacities with each other of the antenna systems for vehicle 120 to 230, the communication capacities of the antenna systems for vehicle 120 to 230 were calculated with respect to default configuration 1 in Example 3. Table 2 indicates a comparison result of the communication capacity of the antenna system for vehicle according to each example. Table 2 corresponds to Table 1 except for the rightmost column. The rightmost column lists the communication capacity of the antenna system for vehicle according to each example relative to the communication capacity of default configuration 1 of Example 3.

TABLE 2
Comparison result of communication capacity of antenna
system for vehicle according to each Example

| | | | | | Communication capacity |
|---|---|---|---|---|---|
| | Arrangement position | | | | Communication capacity |
| | Antenna 31 | Antenna 32 | Antenna 33 | Antenna 34 | relative to default |
| | (V polarized | (H polarized | (H polarized | (V polarized | configuration 1 Example 3, |
| | wave) | wave) | wave) | wave) | [%] |
| Antenna system for | WS | WS | WS | WS | 117 |
| vehicle 120 | First | Center | Center | Second | |
| (Example 3) | periphery | | | periphery | |
| Antenna system for | WS | WS | WS | WS | 124 |
| vehicle 130 | Center | First | Second | Center | |
| (Example 4) | | periphery | periphery | | |
| Antenna system for | RG | RG | RG | RG | 113 |
| vehicle 140 | First | Center | Center | Second | |
| (Example 5) | periphery | | | periphery | |
| Antenna system for | RG | RG | RG | RG | 115 |
| vehicle 150 | Center | First | Second | Center | |
| (Example 6) | | periphery | periphery | | |
| Antenna system for | WS | RG | RG | WS | 117 |
| vehicle 160 | First | First | Second | Second | |
| (Example 7) | periphery | periphery | periphery | periphery | |
| Antenna system for | RG | WS | WS | RG | 108 |
| vehicle 170 | First | First | Second | Second | |
| (Example 8) | periphery | periphery | periphery | periphery | |
| Antenna system for | WS | RG | RG | WS | 115 |
| vehicle 180 | First | Center | Center | Second | |
| (Example 9) | periphery | | | periphery | |
| Antenna system for | RG | WS | WS | RG | 109 |
| vehicle 190 | Center | First | Second | Center | |
| (Example 10) | | periphery | periphery | | |
| Antenna system for | WS | RG | RG | WS | 119 |
| vehicle 200 | Center | First | Second | Center | |
| (Example 11) | | periphery | periphery | | |
| Antenna system for | RG | WS | WS | RG | 104 |
| vehicle 210 | First | Center | Center | Second | |
| (Example 12) | periphery | | | periphery | |
| Antenna system for | WS | RG | RG | WS | 118 |
| vehicle 220 | Center | Center | Center | Center | |
| (Example 13) | | | | | |
| Antenna system for | RG | WS | WS | RG | 105 |
| vehicle 230 | Center | Center | Center | Center | |
| (Example 14) | | | | | |

As indicated in Table 2, among the antenna systems for vehicle according to Examples 3 to 14, the antenna system for vehicle 130 according to Example 4 has the largest increase in communication capacity. The antenna system for vehicle 130 according to Example 4 has a configuration in which the antennas 31 to 34 are arranged on the windshield 12. The antennas 31 to 34 are arranged on the windshield 12 on a front face in the traveling direction of the vehicle 10, and thus the antennas 31 to 34 can receive more radio waves transmitted from a communication apparatus (not shown) facing the antenna system for vehicle 130.

Specifically, the radio waves transmitted from the communication apparatus are reflected by buildings and the like, and reach the antennas 31 to 34 as a plurality of radio waves due to multipath. When the antennas 31 to 34 are arranged on the windshield 12 on a front face in the traveling direction of the vehicle 10, more radio waves can be received compared to a case where the antennas 31 to 34 are arranged on the rear window 13, and thus antenna gains of the antennas 31 to 34 can also be improved. Therefore, it is considered that the communication capacity of the antenna system for vehicle 130 is higher than an example in which at least one of the antennas 31 to 34 is arranged on the rear window 13.

Here, in the antenna system for vehicle 120 according to Example 3, the antennas 31 to 34 are also arranged on the windshield 12, but the antennas 31 and 34 serving as the vertically polarized wave antennas are arranged close to the pillar 11wa and the pillar 11wc. On the other hand, in the antenna system for vehicle 130 according to Example 4, the antennas 32 and 33 serving as the horizontally polarized wave antennas are arranged close to the pillar 11wa and the pillar 11wc. When the horizontally polarized wave antennas are arranged close to the pillars, the horizontally polarized wave antennas can receive radio waves via the pillars. In other words, the antennas 32 and 33 serving as the horizontally polarized wave antennas can receive radio waves via the pillar 11wa and the pillar 11wc. As a result, it is considered that the antenna gains of the antennas 32 and 33 according to Example 4 are higher than those of the antennas 31 and 34 according to Example 3 and the communication capacity is increased. Accordingly, it is confirmed that the antennas 31 to 34 are arranged as in the antenna system for vehicle 130 according to Example 4 and thus a higher communication capacity can be achieved.

As described above, the antennas 31 and 34 included in the MIMO antenna 30 are configured as the vertically polarized wave antennas, the antennas 32 and 33 are configured as the horizontally polarized wave antennas, and these antennas are dispersedly arranged in the vehicle 10, whereby the communication capacity can be improved. Accordingly, according to the antenna system for vehicle of the embodiment, the communication capacity can be improved.

Although the present invention has been described with reference to the above embodiment, the present invention is not limited only to the configuration of the above embodiment, but includes various modifications, alterations, and combinations which can be made by those skilled in the art within the scope of the claims of the present application, as a matter of course.

What is claimed is:

1. An antenna system for vehicle, comprising:
a vehicle; and
a MIMO antenna that is mounted on the vehicle and transmits and receives radio waves of a predetermined frequency, wherein
the MIMO antenna includes four antennas including a first antenna that mainly transmits and receives a first polarized wave and a second antenna that mainly transmits and receives a second polarized wave orthogonal to the first polarized wave, the four antennas being dispersedly arranged on the vehicle, and
when a central region is defined as a region having widths equidistant to each other in a left-right vehicle width direction from the center line that bisects a vehicle width when viewed in a vertical direction of the vehicle, a first peripheral region and a second peripheral region are defined as two regions with the central region interposed therebetween, a first region is defined as a front region of the vehicle using an arbitrary line extending in the vehicle width direction as a boundary, and a second region is defined as a rear region of the vehicle relative to the first region,
the first antenna and the second antenna are arranged based on at least one of:
(1) a configuration in which one is arranged in the central region and another one is arranged in the first peripheral region or the second peripheral region; and
(2) a configuration in which one is arranged in the first region and another one is arranged in the second region.

2. The antenna system for vehicle according to claim 1, wherein the MIMO antenna includes a third antenna that mainly transmits and receives the first polarized wave and a fourth antenna that mainly transmits and receives the second polarized wave.

3. The antenna system for vehicle according to claim 2, wherein one of a first antenna group including the first antenna and the third antenna and a second antenna group including the second antenna and the fourth antenna is arranged in the central region, and another one is arranged in at least one of the first peripheral region and the second peripheral region.

4. The antenna system for vehicle according to claim 3, wherein
the first antenna and the third antenna are arranged in the central region, the second antenna is arranged in the first peripheral region, and the fourth antenna is arranged in the second peripheral region, or
the first antenna is arranged in the first peripheral region, the third antenna is arranged in the second peripheral region, and the second antenna and the fourth antenna are arranged in the central region.

5. The antenna system for vehicle according to claim 4, wherein
the first antenna and the third antenna are arranged at positions apart by the same distance from the center line, and
the second antenna and the fourth antenna are arranged at positions apart by the same distance from the center line.

6. The antenna system for vehicle according to claim 2, wherein
the arbitrary line is provided on a roof of the vehicle, and
the MIMO antenna is arranged in the first region or the second region.

7. The antenna system for vehicle according to claim 6, wherein the MIMO antenna is arranged on a windshield.

8. The antenna system for vehicle according to claim 6, wherein the MIMO antenna is arranged on a rear window.

9. The antenna system for vehicle according to claim 2, wherein
the arbitrary line is provided on a roof of the vehicle, and
one of a first antenna group including the first antenna and the third antenna and a second antenna group including the second antenna and the fourth antenna is arranged in the first region, and another one is arranged in the second region.

10. The antenna system for vehicle according to claim 9, wherein one of the first antenna group and the second antenna group is arranged on a windshield, and another one is arranged on a rear window.

11. The antenna system for vehicle according to claim 2, wherein when the predetermined frequency is defined as λ, a wavelength shortening rate of a dielectric to which the first antenna and the third antenna are attached is defined as k₁, and a wavelength shortening rate of a dielectric to which the second antenna and the fourth antenna are attached is defined as k₂,
a distance between the first antenna and the third antenna is k₁×λ/2 or more, and
a distance between the second antenna and the fourth antenna is k₂×λ/2 or more.

12. The antenna system for vehicle according to claim 1, wherein
the first polarized wave is a vertically polarized wave, and the second polarized wave is a horizontally polarized wave,
the first antenna is a vertically polarized wave antenna that mainly transmits and receives the vertically polarized wave, and
the second antenna is a horizontally polarized wave antenna that mainly transmits and receives the horizontally polarized wave.

13. The antenna system for vehicle according to claim 2, wherein
the first polarized wave is a vertically polarized wave, and the second polarized wave is a horizontally polarized wave,
the first antenna and the third antenna are vertically polarized wave antennas that mainly transmit and receive the vertically polarized wave, and
the second antenna and the fourth antenna are horizontally polarized wave antennas that mainly transmit and receive the horizontally polarized wave.

14. The antenna system for vehicle according to claim 1, wherein a width Wc of the central region satisfies the following relationship when a width of the vehicle is defined as W
0.1×W≤Wc≤0.5×W.

15. The antenna system for vehicle according to claim 1, wherein an antenna, which is arranged in either the first peripheral region or the second peripheral region, in the MIMO antenna is arranged apart from a pillar of the vehicle by a distance of 100 mm or less.

16. The antenna system for vehicle according to claim 1, wherein the predetermined frequency is 3.3 GHz or more.

17. The antenna system for vehicle according to claim 1, wherein the predetermined frequency is 6 GHz or less.
